(19) United States
(12) Patent Application Publication
(10) Pub. No.: US 2021/0229408 A1
(43) Pub. Date: Jul. 29, 2021

(54) ORIENTED POLYOLEFIN RELEASE FILMS

(71) Applicant: Toray Plastics (America), Inc., North Kingstown, RI (US)

(72) Inventors: Shichen Dou, North Kingstown, RI (US); Masato Ushijima, North Kingstown, RI (US)

(21) Appl. No.: 16/775,290

(22) Filed: Jan. 29, 2020

(51) Int. Cl. B32B 27/32; B32B 27/28

(52) U.S. Cl. CPC B32B 27/32; B32B 27/283; B32B 2250/03; B32B 2307/748; B32B 2310/14; B32B 2307/516; B32B 2307/518; B32B 2250/24

(57) ABSTRACT

Embodiments relates to a multilayer film comprising a core layer, a first outer layer and second outer layer. In an embodiment, the core layer includes a polypropylene; the first outer layer comprises (a) a polymethylpentene, (b) a butene copolymer, and (c) a polydimethylsiloxane and/or a crosslinked silicone; and the second outer layer comprises (a) a polymethylpentene, (b) a butene copolymer, and (c) a polydimethylsiloxane and/or a crosslinked silicone. Yet, another embodiment relates the core layer comprises polypropylene; the first outer layer comprises a mini random polypropylene resin, wherein the first outer layer comprises a first corona treated surface; and the second outer layer comprises a polymethylpentene copolymer, a crystalline polypropylene, a polydimethylsiloxane, a crosslinked silicone and/or a fluoropolymer.

### RELATED APPLICATIONS

This application is related to U.S. patent application Ser. No. 15/442,318, entitled “MONOAXIALLY OR BIAXIALLY ORIENTED POLYOLEFIN RELEASE FILM,” filed on Feb. 24, 2017, which is incorporated herein in its entirety.

### FIELD OF INVENTION

Embodiments are directed to a multilayered oriented polyolefin release film essentially comprising a core layer containing homopolypropylene (homoPP); a first outer layer which provides easy release functionality comprising a polymethylpentene (PMP) or PMP copolymer (a copolymer of 4-methyl-1-pentene with ethylene or alpha-olefin monomer) or the mixture thereof; and a second outer layer comprising thermoplastic polymers optionally suitable for release, heat-sealing, adhesion, and printing or coating. The release films are “free of silicone” and therefore intended to replace silicone-coated paper release liner or silicone-coated polymeric release liner for improving recyclability and/or reducing carbon gas generation footprint.

### BACKGROUND OF INVENTION

A release film in general has at least one surface layer characterized by a low surface energy that serves to protect and allows handling of various materials and articles, such as adhesives or articles coated with an adhesive. In the final application it can be easily separated from the adhesives applied to the surfaces of molds or molded parts due to the weak adhesion between the release film surface and the surface directly contacting said release film surface. Examples include pressure-sensitive adhesive labels, cold seal packaging films, injection-molded and composite parts, and various films used as protective films. Release films comprise at least one outer layer with low surface energy to provide release functionality and a base polymer layer to provide mechanical strength.

Release films are most commonly used as the outer layer containing a multilayered laminate structure which requires for weak adhesion or prevention of forming cohesion (“blocking”) with an adhesive layer coated onto the opposite side of the release layer, for example, as it is wound into a roll form. It must also perform multiple functionalities including mechanical and optical properties; and optionally other properties provided by a promoting layer suitable for laminating, coating, and printing. “Blocking” is the unwanted adhesion between the substrate layer and the release layer under the conditions of pressure and aging.

Silicone-coated paper liners or silicone-coated mono or biaxially oriented polyester (BOPET) or polypropylene (BOPP) films are still commonly used for release applications due to both their very low release force to a number of different substrates and their relatively low cost compared to expensive release films such as fluoropolymer release films or monolithic PMP release films. However, the presence of silicone has a problem with recyclability of the release film after application; and also residual low molecular weight silicone moieties in the release layer have a tendency to transfer over to the surface of the material being released from, and potentially causing further downstream processing problems.

Blocking resistance and release capability are the crucial factors of the release films required by the end users. To achieve these objectives in a cost-effective manner, one needs to formulate the release layer using thermoplastic polymers and additives which are excellent in releasability and processability.

One-side release films and two-side differential release films have specific functional requirements, and there are key distinctions between these functions. One-side liners carry an adhesive (coated on the opposite side of the release layer film or laminate) that is laminated to another film or paper substrate, e.g. a pressure-sensitive adhesive label. This type of one-side release liner primarily serves as a delivery mechanism for adhesive-coated labels for automatic or manual labeling of articles and graphic arts applications. Another example of one-side release film is cold seal release film which is firstly printed on the non-release layer opposite the release layer, and then the printed surface is laminated to a gas barrier film able to be coated with cold seal adhesive on the opposite side. The release layer directly contacts the cold seal adhesive layer when wound into a roll form.

In comparison, differential (two-sided) release liners are typically used to carry an adhesive that must be wound together with the release liner upon itself and then unwound for use. In such a wound roll, both surfaces of the adhesive film are contacting the two surfaces of a release liner. To work properly, the release film must have two different release values (surface energies) for proper performance. Another example of two-side release film is the release film used for molding or print transfer. One side of the release film is released from the surface of a molding tool as the molding process is complete, and the opposite side of the release film remains adhered to the molded part surface as a protective film which can be peeled off from the molded part easily afterwards as required. In the new technology of print transfer, the first release layer (side) of the release film is coated with a protective coating on which graphics are then printed; subsequently a pressure sensitive adhesive is coated to form a wound roll. The first release layer is not only printable (a coating) but also is releasable. To transfer printed graphics successfully, the adhesion force between the interface needs to follow the order of: 1) protective coating/graphics>2) graphics/PSA>3) PSA/substrate>4) 1^{st} release layer/protective coating>5) 2^{nd} release layer/PSA>6) 2^{nd} release layer/graphics>2^{nd} release layer/protective coating.

Both pressure sensitive adhesives and cold seal adhesives are amorphous rubbery materials with extremely low glass transition temperature (Tg<<0° C.) which are very sticky and tacky under ambient temperature environment, rendering them good candidate materials to evaluate the release performance and adhesion affinity of a release film.

PMP films have low surface energy (24 mN/m, which is comparable to the surface energy of solid silicones), only slightly higher than the surface energy of polytetrafluoroethylene (PTFE, 20 mN/m). PMP films have found application as release films and demonstrate release functionality to the substrates coated with adhesives or pressure sensitive adhesives or molding tools, and molded parts as they are in direct contact. However, PMP release films have a high cost disadvantage in that they are only available in the unoriented extruded state due to their poor stretchability.

Efforts in the prior art have been devoted to reducing the cost of the PMP-based release film by coextrusion and multilayer solutions. Coextruded PMP release films comprise one or two PMP outer layers, intermediate layers (adhesion tie layers), and one core layer. Adding intermediate layers (tie layers) is necessary to prevent the delamination between the PMP outer layer and the core layer. The resin of the core layer is commonly selected from polyamide (Nylon 6) or polyamide copolymer (Nylon 6/66) for their characteristics of high melting temperature. However, those prior art PMP release films are non-oriented or oriented only in the machine direction at a low stretching ratio of from 2× to 4× times, resulting in limitations with respect to downgauging as well as tensile strength.

U.S. Pat. No. 5,534,593 discloses a composition which comprises a blend of 50 to 70% PMP and 50 to 30% polypropylene (PP). The films made with the blend have improved elongation (stretchability) and release properties. The films were stretched in machine direction by a ratio of from 2× to 4×, depending on the melt flow rate (MFR) of PMP resins. The release force to the surface of a pre-cast sheet (substrate) is as high as in the range of 213 to 527 Win under ambient condition, and of 259 to 599 g/in for heat aged condition (51.7° C. or 125° F. for 72 hours).

A series of U.S. Pat. Nos. 5,858,550; 6,270,909; 6,440,588 disclose methods of making heat-resistant PMP release films comprising at least one outer layer containing polymethylpentene, one intermediate layer (tie layer) and one core layer containing polyamide polymer (Nylon 6). The tie layer comprises a blend of maleic anhydride grafted polypropylene (or other modified polyolefin resins) and polyamide. The coextruded multilayered composite films were stretched by a ratio of 3× in machine direction and have excellent thermal stability in dimension at temperatures up to 177° C. However, the polymer compositions comprised in the PMP release film render it not recyclable after application due to the incompatibility of the PMP outer layer and polyamide core layer.

U.S. Pat. No. 10,336,033 discloses a method of making coextruded non-oriented multilayered heat-resistant release films comprising two outer layers with different adhesion affinity, an elongation core layer with polyamide copolymer and two tie layers with polymeric adhesive. The first outer layer is configured to exhibit a weaker adhesion to the surface of molding tools while the second outer surface is configured to exhibit a stronger adhesion to the surface of the part being cured. In other words, the release force measured for the first outer layer is lower than that of the second outer layer. The polymeric materials for outer layers include PMP and poly(ethylene-co-tetrafluoroethylene) (ETFE). The second outer layer was modified with polymeric adhesion-adjusting additive to achieve “stronger adhesion”. However, the polymer compositions comprised in the release film are not easily recyclable after application.

U.S. Pat. No. 7,314,905 discloses a method of making coextruded three-layer films with PMP copolymer and PP at a draw ratio of from 4× to 8× in machine direction. The PMP copolymer was synthesized from 4-methyl-1-pentene monomer and monomers of ethylene or alpha-olefin used for modifying structure to improve processability. The three-layer films have a structure of PP/PMP copolymer/PP. The lamination bond (peeling force) of the oriented laminate between layers of PP and PMP is 169 g/in or less. The PP outer layers can be easily peeled off from PMP copolymer inner layer; subsequently, the single PMP copolymer layer (with a thickness of 40 μm) is used as a two-sided release film applied to a rough surface of oxidized copper foil of a copper-clad laminate in multilayer printing wiring board. The thickness of the PMP film is up to 40 μm, which has a significant cost impact on the final application.

US Patent Application 2018/0244024 describes a method of making coextruded oriented polyolefin release film comprising at least one outer layer and a polypropylene core layer, the release layers of the film comprise PMP resin and other thermoplastic polyolefin resins formulated to having differentiated properties of “easy release” and different adhesion affinity. The polyolefin release film was oriented at ratio of 4× to 6× in machine direction and 8× to 10× in transverse direction. The polymer compositions in the PMP release film render it having good recyclability after application as the PMP resin in the release layer can be well dispersed in the matrix of thermoplastic polyolefin by a melt extrusion process. However, the inventor did not demonstrate and describe the release capability of the invented films to the surface of rubbery adhesives (e.g. cold seal adhesives and pressure sensitive adhesives).

CN108790346 discloses release paper for rapid compression of a flexible circuit board. The release paper comprises a PMP silicon-free release layer, a buffering layer, a raw paper layer and a polybutylene phthalate (PBT) back coating ventilating layer. The PMP silicon-free release layer is formed on the upper surface of the buffering layer. The buffering layer is formed on the upper surface of the raw paper layer. The PBT back coating ventilating layer is formed on the lower surface of the raw paper layer. Multiple ventilating holes are uniformly distributed in the PBT back coating ventilating layer.

U.S. Pat. No. 5,948,517 discloses a silicone-free release film comprises a linear ethylenic polymer having a density from 0.865 to 0.900 g/cc and an index of polydispersity of less than 5.0 and yields a maximum release force value of 39 g/cm at a film thickness of 0.10 to 0.15 mm in an adhesive peel test. The film is useful in manufacturing rolls and sheets of pressure-sensitive adhesive tape. The invention is a release film having a maximum release force value of 39 g/cm (0.22 lbs/inch) at a film thickness of 0.1 to 0.15 mm (4-6 mils) in an adhesive peel test, the release film comprising a linear ethylenic polymer having a density from 0.865 g/cc to 0.900 g/cc and an index of polydispersity of less than 5.0, wherein the release film is substantially free of silicone.

US Patent Application 2006/0105190 discloses a film that has high rigidity and high heat resistance and good releasability from a roughened copper foil surface, which is subjected to surface oxidization or etching treatment with acid, such as a black oxidized copper foil surface and that is suitable as a release film for producing an MLB; and a process for producing the same. A drawn film having a layer (A) which comprises a copolymer that is made from 4-methyl-1-pentene and ethylene or an alpha-olefin, except 4-methyl-1-pentene, having 3 to 20 carbon atoms and that comprises 80% or more by mole of 4-methyl-1-pentene, the thermal coefficient of contraction of the film being 20% or more in the film-drawn direction, or the peel area of the film being 50% or more when the film, together with a copper foil surface subjected to roughening treatment, is subjected to heating and pressing treatment. This film is suitable for producing an MLB and has good releasability from the roughened copper foil surface, for example, a black oxidized copper foil surface.

In the embodiments herein, a coextruded oriented polyolefin release film comprises at least one outer layer comprising PMP or PMP copolymer as the primary resin in the release layer, which is defined as “PMP release film”; the release layer comprising PMP polymer or PMP copolymer is defined as “PMP release layer”.

None of the practices in the prior art has demonstrated an economic method to make a resultant PMP release film intended to replace silicone-coated BOPP and silicone-coated BOPET films used in a direct contact to the surface of adhesives, molding tools or molded parts.

### SUMMARY OF THE INVENTION

An embodiment relates to a multilayer film comprising a core layer and a first outer layer; wherein the core layer comprises a first polypropylene; and wherein the first outer layer comprises (a) a first polymethylpentene and (b) a first polydimethylsiloxane and/or a first crosslinked silicone.

In an embodiment, the first outer layer further comprises a first butene copolymer.

In an embodiment, the first outer layer further comprises a first fluoropolymer.

In an embodiment, the first outer layer further comprises a first ethylene-propylene copolymer.

In an embodiment, the first outer layer further comprises a first polypropylene copolymer.

In an embodiment, the first outer layer comprises a first corona treated surface.

In an embodiment, the multilayer film further comprises a second outer layer, wherein the second outer layer comprises a second polypropylene and a silicate.

In an embodiment, the multilayer film further comprises a second outer layer, wherein the second outer layer comprises (a) a second polymethylpentene, (b) a second butene copolymer, and (c) a second polydimethylsiloxane and/or a second crosslinked silicone.

The multilayer film of claim 8, wherein the second outer layer further comprises a second fluoropolymer.

In an embodiment, the second outer layer further comprises a second ethylene-propylene copolymer.

In an embodiment, the second outer layer further comprises a second polypropylene copolymer.

In an embodiment, the second outer layer comprises a second corona treated surface.

In an embodiment, the first outer layer comprises the first polydimethylsiloxane and the first crosslinked silicone.

In an embodiment, the core layer further comprises a hydrogenated hydrocarbon resin.

In an embodiment, the multilayer film is free of silicone.

Another embodiment relates to a multilayer film comprising a core layer and a first outer layer; wherein the core layer comprises polypropylene; and wherein the first outer layer comprises a mini random polypropylene resin, wherein the first outer layer comprises a first corona treated surface.

In an embodiment, the multilayer film further comprises a second outer layer comprising a polymethylpentene copolymer.

In an embodiment, the multilayer film further comprises a second outer layer comprising a crystalline polypropylene, a second polydimethylsiloxane, a second crosslinked silicone and/or a second fluoropolymer.

In an embodiment, the second outer layer further comprises a second polydimethylsiloxane, a second crosslinked silicone and/or a second fluoropolymer.

In an embodiment, the second outer layer further comprises a second polydimethylsiloxane, a second crosslinked silicone and a second fluoropolymer.

In an embodiment, the core layer further comprises a hydrogenated hydrocarbon resin.

In an embodiment, the multilayer film is free of silicone.

In an embodiment, the multilayer film is completely free of silicone.

### DETAILED DESCRIPTION OF THE INVENTION

All publications, patents, and patent applications cited in this Specification are hereby incorporated by reference in their entirety.

The singular forms “a,” “an” and “the” are used herein to refer to one or to more than one (i.e., to at least one) of the grammatical object of the article. By way of example, “a component” means one component or more than one component.

Any ranges cited herein are inclusive.

For simplicity and clarity of illustration, the drawing FIGURES illustrate the general manner of construction, and descriptions and details of well-known features and techniques may be omitted to avoid unnecessarily obscuring the present disclosure. Additionally, elements in the drawing FIGURES are not necessarily drawn to scale. For example, the dimensions of some of the elements in the FIGURES may be exaggerated relative to other elements to help improve understanding of embodiments of the present disclosure. The same reference numerals in different FIGURES denotes the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The present invention may be embodied in other specific forms without departing from its spirit or characteristics. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, the trash recycling methodologies described herein are those well-known and commonly used in the art.

Before the embodiments are described, it is to be understood that this disclosure is not limited to the particular processes, methods and devices described herein, as these may vary. It is also to be understood that the terminology used herein is for the purpose of describing the particular versions or embodiments only and is not intended to limit the scope of the present disclosure which will be limited only by the appended claims. Nothing in this disclosure is to be construed as an admission that the embodiments described in this disclosure are not entitled to antedate such disclosure by virtue of prior invention. As used in this document, the term “comprising” means “including, but not limited to.”

Embodiments herein relate to a multi-layer oriented polyolefin release film comprises a core layer; at least an outer layer comprising a PMP or polymethylpentene copolymer (PMP copolymer) for easy release from the surface of adhesives, molds or molded parts; and a second outer layer with the functionalities of, optionally, either release, or heat sealing, or winding, or printing/coatings or adhesion. The second outer layer could have a differentiated adhesion affinity different from the adhesion affinity of the first outer layer.

Embodiments herein include:

Release films comprising a polypropylene core and an outer layer containing a PMP.

Release films comprising a polypropylene core, a first outer layer containing PMP and a second outer layer containing thermoplastic (polyolefins) polymers.

Release films comprising a polypropylene core containing a hydrogenated hydrocarbon resin.

Release films comprising a polypropylene core containing a hydrogenated hydrocarbon resin, a first outer layer containing PMP and second outer layer containing a thermoplastic (polyolefins) polymers.

Release films comprising a polypropylene core and an outer layer containing PMP, wherein the release films are free of silicon.

Release films comprising a polypropylene core, a first outer layer containing PMP and second outer layer containing thermoplastic (polyolefins) polymers, and wherein the release films are free of silicon.

Release films comprising a polypropylene core, wherein the polypropylene contains less than 3 wt % of xylene soluble ingredients.

Release films comprising a polypropylene core having a hydrogenated hydrocarbon resin, wherein the polypropylene contains less than 3 wt % of xylene soluble ingredients, a first outer layer containing PMP, and a second outer layer containing thermoplastic (polyolefins) polymers.

In an embodiment, the materials on the outer surface of a release layer essentially include those which have low surface energy (e.g. PTFE, PMP, and silicone), and those which are incompatible (e.g. HCPP crystals) with the adhesive layer; those which are compatible (amorphous rubbery resins) with adhesive layer; and those which are not transferable (e.g. firmly embedded anti-blocking and slip additives), and those which are transferable (free species on the top surface: e.g. silicone oils, migratory waxes and anti-blocking and slip additives). The materials that increase the release property include materials with low surface energy, polymer crystals, and embedded anti-blocking particles. The materials that have strong tendency to stick to or adhere to the adhesive layer or receptive substrate include amorphous materials, debris of small molecules, rubbery or moveable polymer chain segments or tails, free particles (migratory) and rubbery materials. Small molecules and particles have strong tendency to transfer onto the surface of adhesive layer or receptive substrate, resulting in unwanted contamination. The domains of amorphous materials such as rubbery amorphous polymer domains, chain segments, and tails on the top surface have a tendency to form cohesion with the molecules of the adhesive layer. Both surface contamination and cohesion could significantly lead to the formation of blocking between laminated layers. Generally, the release properties of a release film are evaluated under both ambient and heat aged conditions to determine the release performance of a release film. Desirable anti-blocking and slip agents include those having low surface energy, and low adhesion to the adhesive surface or receptive substrate; and low and stable COF under elevated temperature conditions (also known as “hot slip” COF). Desirable polymers for the outer layer include those which are incompatible with the materials used in the adhesive layer and receptive substrate. In an embodiment, a PMP is a candidate for release application to an adhesive layer or sticky surface.

An embodiment relates to a multilayered oriented polyolefin release film comprises a core layer (B); a first outer layer (A) which is a release layer to provide easy release from a surface of adhesives or the surface of molds or molded parts; and a second outer layer (C) with functionalities of, optionally, either release, or heat sealing, or winding, or adhesion, coating or printing. The polyolefin release film is coextruded and then oriented either uniaxially or biaxially, and preferably is biaxially oriented in both the machine and transverse directions.

In an embodiment, the core layer containing the release film is a layer containing polypropylene homopolymer, or highly isotactic crystalline polypropylene (HCPP) blended with 0 to 25 wt % non-migratory hydrogenated hydrocarbon resins (HCR) as processing aid to improve stiffness and barrier properties. Optionally, a desirable amount of migratory slip or antistatic additives in the range of from 0 to 1000 ppm could be added into the core layer. Optionally, the core layer is cavitated or pigmented.

In an embodiment, the outer layer comprises a blend of a PMP, polymethylpentene copolymer (PMP copolymer), a desirable amount of other different thermoplastic polymers and spherical anti-blocking agents and slip agents.

In an embodiment, the outer functional layer essentially comprises thermoplastic polymers and a desirable amount of spherical anti-blocking particles and slip agents.

In an embodiment, optionally, the multilayered oriented polyolefin release film comprises at least one intermediate layer. The intermediate layer is located between the outer layer and the core layer.

In an embodiment, the outer layer contains a thermoplastic polymer that is selected from polymethylpentene, polymethylpentene copolymer, highly isotactic crystalline polypropylene (HCPP), homopolypropylene, polybutene-1 (PB-1) copolymers, and polypropylene copolymers.

In an embodiment, the outer layer containing the thermoplastic polymer comprises 10 to 100 wt % of polymethylpentene (PMP) or polymethylpentene copolymer or the blend thereof, preferably, 50 to 99.5 wt % PMP or PMP copolymer; 0 to 90 wt % high crystalline polypropylene (HCPP); 0 to 25 wt % polybutene-1 copolymers; 0 to 25 wt % polypropylene copolymers; and optionally 0 to 25 wt % maleic anhydride modified polyolefin or ionomers.

In an embodiment, the outer layer contains optionally the thermoplastic polymers in another embodiment comprise polypropylene homopolymer, polypropylene copolymer, polyethylene (e.g. LLDPE, LDPE, MDPE or HDPE polyethylene resins known in the prior art), polybutene-1 (PB-1) copolymers, or the blend thereof at an amount of from 0 to 50 wt % the total weight of the outer layer.

In an embodiment, the outer layer contains a high crystalline polypropylene having xylene solubles less than 3 wt %, more preferably, less than 2.5 wt % and a melt flow rate of 2 to 4 g/10 min. (2.16 Kg/230° C.).

In an embodiment, the outer layer contains polybutene-1 (PB-1) copolymers are the copolymers of butane-1 and propylene, and the copolymers of butane-1 and ethylene. The PB-1 copolymers have a melt flow rate of 2 to 12 g/10 min. (2.16 Kg/190° C.) and a melting temperature of 50 to 130° C.

In an embodiment, the outer layer contains spherical anti-blocking particles are the particles of crosslinked silicones, Silton® JC-30 antiblock, and synthetic SiO2. The size of spherical particles is preferably in the range of from 1 to 6 μm, more preferably, in the range of from 2 to 4 μm.

In an embodiment, the outer layer contains a slip agent is preferably partially crosslinked polydimethylsiloxane (PDMS) which is produced by reactive extrusion compounding. The active content in the masterbatch is in the range of about 10 to 50 wt %. The size of partially cross-linked irregular PDMS particles is in the range of 0.25 to 10 μm, more preferably, in the range of from 0.5 to 4 μm.

In an embodiment, the outer functional layer contains anti-blocking and slip agents that could be selected from those used in the outer layer or any of those in the prior art at a desirable amount of 0.02 to 2.0 wt % the total weight of the outer functional layer.

In an embodiment, the film further comprises an intermediate layer containing a blend of polymethylpentene, polymethylpentene copolymer, homopolypropylene, polybutene-1 copolymers, polypropylene copolymers, maleic anhydride modified polyolefins, ionomers and thermoplastic elastomers which could promote the adhesion between the core layer and the outer layer.

In an embodiment, the multilayered oriented polyolefin release film is a two-layer film which comprises a core layer and an outer layer, the outer surface of the core layer opposite to the outer layer is discharge treated for printing, adhesion, and coating. A sufficient amount of anti-blocks and slip agents is added into the core layer to provide a surface COF required for winding and machinability.

In an embodiment, the multilayered oriented polyolefin release film is a three-layer film which comprises a core layer, intermediate layer, and an outer layer, the outer surface of the core layer opposite to the outer layer is discharge treated for printing, adhesion, and coating. A sufficient amount of anti-blocks and slip agents is added into the core layer to provide a surface COF required for winding and machinability.

In an embodiment, the two outer layers comprise the different compositions to differentiate the adhesion affinity of each outer layer for easy release from a surface of a material. No surface discharge treatment was applied to both outer layers.

In an embodiment, the two outer layers comprise the same compositions while surface discharge treatment at a desirable energy output level (from 0 to 200%) is applied to one of the outer layers to differentiate the surface energy and adhesion affinity between two outer layers. The surface treatment could be corona discharge treatment, flame, or high densities of energy flux.

In an embodiment, the multilayered oriented polyolefin release film is oriented mono-axially 3× to 6× times in machine direction to its original length, preferably is then oriented 5× to 10× times of its original width in transverse direction.

In an embodiment, the multilayered oriented polyolefin release film is in the range of from 10 to 200 microns, preferably 20 to 100 microns.

In an embodiment, the outer layer contains thickness of the outer layer is in the range of from 0.5 to 6 μm, more preferably, 0.5 to 4 μm.

In an embodiment, the outer layer has surface energy in the range of from 15 to 42 dynes/cm, measured by water-drop contact angle method and converted to surface energy, preferably, in the range of 18 to 30 dynes/cm.

In an embodiment, the outer layer contains outer layer has a dynamic COF of 0.15 to 0.50, preferably, of 0.15 to 0.30.

In an embodiment, the outer layer contains outer layer has release force to PSA adhesive less than 30 g/in, and to cold seal adhesive less than 50 g/in.

In an embodiment, the outer layer contains outer layer has a tape peeling force less than 800 Win, preferably, less than 500 g/in.

In an embodiment, the outer layer contains outer layer has a surface roughness Ra less than 300 nm, preferably, less than 150 nm, more preferably, less than 50 nm.

In an embodiment, the outer layer contains delamination bond between the outer layer and the core layer is higher than 75 g/in, preferably, higher than 100 g/in, more preferably, higher than 150 g/in.

The embodiments are directed to a coextruded oriented PMP release film with improved processability and release performance suitable for both the release application of pressure sensitive adhesives (PSA), cold seal adhesives (CSA), and other industrial adhesives. The PMP release film can be recyclable internally in the film-making process and externally after the post-consumer application.

In an embodiment, for a coextruded three-layer (A/B/C) PMP-based release film, the release film comprises a core layer (B) and two outer layers (A) and (C). The outer PMP release layer could be either outer layer (A) or both (A) and (C). The first outer layer (A) which has release functionality to the surface of adhesives, coatings, molded parts or molding tools; the second outer layer (C) which is a functional layer that optionally could be formulated to have release functionality similar to or different from the release capabilities of the first outer layer (A) (in a case of two-side release film), and have properties of heat-sealing, winding, adhesion, coating or printing. The PMP release film is coextruded and then oriented either uniaxially or biaxially, and preferably is biaxially oriented in both the machine and transverse directions.

In an embodiment, the core layer (B) of the coextruded film is essentially a layer containing propylene homopolymer (PP), or high crystalline polypropylene (HCPP) blended with 0 to 25 wt % non-migratory hydrogenated hydrocarbon resins (HCR) as processing aid and to improve stiffness. Optionally, the core layer is cavitated or pigmented.

In an embodiment, the outer PMP-containing release layer (A) essentially comprises polymethylpentene, copolymers of polymethylpentene, polypropylene, or polybutene-1 polybutene-1 (PB-1) copolymers, or polypropylene copolymers, modified polyolefins, and blends thereof; and a desirable amount of anti-blocking agents and slip agents including spherical anti-blocking particles, such as synthetic SiO2 (e.g. SYLOBLOC® silica), crosslinked silicones (e.g. Tospearl® crosslinked silicone microsphere particles), and partially crosslinked polydialkylsiloxane particles.

In an embodiment, the outer functional layer (C) comprises thermoplastic polymers to provide functionalities of, optionally, release, printing, heat sealing, coating and adhesion; and a desirable amount of anti-blocking and slip agents.

In an embodiment, in a two-side PMP release film, the second outer PMP release layer (C) comprises a blend of polymers and additives that could be the same as or different from that of the first outer PMP release layer. The differential release capability of the second PMP release layer could be controlled by either changing the compositions of the release layers or changing the surface energy treatment on the outer layers.

In one embodiment, intermediate layers (D and F) of thermoplastic polymers could be incorporated into the structure between the core layer (B) and each outer layer (A) and (C) of the PMP release film as special intermediate functional layers. The PMP release film could have a four or five layer structure of A/D/B/C, A/B/D/C, A/D/B/D/C, A/D/B/F/C, and A/D/F/B/C. Further intermediate layers could be inserted as well. The intermediate layers can be used as the functional structure layer for improving the adhesion or lamination bond strength between the outer PMP release layer and core layer and adding migratory additives or providing a function of cavitation or pigmentation.

In another embodiment, the core layer containing the PMP release film comprises propylene homopolymer, optionally, and migratory slip and antistatic additives at a desirable amount of from 0 to 1000 ppm.

In another embodiment, the core layer containing the PMP release film is cavitated or pigmented for the purpose of satisfying the needs of end users.

In another embodiment, the core layer containing the PMP release film comprises high crystalline polypropylene (HCPP) with a xylene solubles <3.0 wt % and hydrogenated hydrocarbon resin at a desirable amount of from 0 to 25%, preferably, 5 to 15 wt %.

In another embodiment, the PMP release film could be a two-layer release film (AB) comprising a core layer (B) and an outer PMP release layer (A), both the core layer and outer layer will be formulated for interfacial lamination bond strength using thermoplastic polymers.

In another embodiment, the PMP release film could be a three-layer release film (A/DB) comprising a core layer (B), one intermediate layer (D) and an outer PMP release layer (A). The intermediate layer (D) will be formulated for promoting the interfacial lamination bond strength between the core layer (B) and the outer layer (A) using thermoplastic polymers.

In another embodiment, the PMP release layer comprises a blend of 10% to 100 wt % PMP or PMP copolymer, or the blend thereof; 0 to 90 wt % HCPP; and 0 to 25 wt % polybutene-1 copolymers; and 0 to 30 wt % polypropylene copolymers; and 0 to 1.5 wt % crosslinked silicone particles or synthetic silica (SiO2) particles or 0 to 10 wt % partially crosslinked polydialkylsiloxane particles.

In another embodiment, the intermediate layer comprises a blend of 0% to 50 wt % PMP or PMP copolymer, 50% to 90 wt % polypropylene, and 0 to 25 wt % polybutene-1 copolymers, and 0 to 30 wt % polypropylene copolymers, and 0 to 20% maleic anhydride modified polyolefins for promoting the adhesion affinity between the PMP outer layer and the core layer.

Additional advantages of the embodiments herein will become readily apparent to those skilled in this art from the following detailed description, wherein only the preferred embodiments are shown and described, simply by way of illustration of the best mode contemplated for carrying out the invention. As will be realized, the invention is capable of other and different embodiments, and its details are capable of modifications in various obvious respects, all without departing from the invention. Accordingly, the description is to be regarded as illustrative in nature and not as restrictive.

To achieve desirable release properties, preferably, a PMP content of 50-100 wt % is required in the release layer. Examples of suitable PMP materials are resin grades from Mitsui Chemical under the “TPX™” trade name family. The polymethylpentene polymer has a bulky side chain, which upon crystallization forms a 72 helical crystal structure. These characteristics provide unique features, namely limited molecular movement even in amorphous phase, resulting in a melting point among the highest among polyolefins: 220-240° C.; very small density difference between the crystal and amorphous phase accompanied by high transparency after thermal crystallization; low packing density between molecules resulting in low density (0.83 g/cm³) and low surface tension resulting in good releasability. Examples of film-grade PMP polymers in the TPX™ family include grades of MX002, MX004, DX845, and RT18. PMP resins are distinguished between other polyolefins by high melting temperature and the melt flow rate (MFR) measured at 260° C. under a load of 5 kg. MX002 resin grade, with a Tm of 224° C. and a MFR of 21 g/10 min., was used in the Examples but other grades are possible for suitable use as well.

The content of PMP resin in the outer layer has a correlation with release force. The higher the PMP loading, the lower the release force. However, higher PMP content can have the effect of poorer processability. As PMP content is reduced to improve processability, other polyolefin resins that provide release capability such as high crystalline polypropylene (HCPP) and polybutene-1 copolymer (e.g. Tamfer™ BL2481M, a 1-butene/alpha-olefin copolymer, Tm=58° C., MFR=9 g/10 min) can be added into the release layer for eliminating the negative impact of PMP loading reduction on release property.

Mitsui Chemicals' AB SORTOMER™ (e.g. grades EP-1001 and EP-1013) is an α-olefin copolymer with molecular structure optimized at the nano-meter level. It has a high tangent delta peak at room temperatures and a hard-tough surface. At higher temperatures than the peak of tangent delta, it becomes soft and flexible. Absortomer™ EP-1013, the copolymer of 1-methyl-1-pentene and α-olefin (a PMP copolymer), has a Tm of 130° C. and a MFR of 10 g/10 min. This PMP copolymer is excellent in flexibility, lightness, stress absorption, relaxation, stable releasability, and processability. While the polymer has the disadvantage of high cost, in a manner of economy, it is better to incorporate the PMP copolymers into a thin outer layer containing a release film.

HCPP homopolymers used in the outer layer are able to provide excellent scratch and blocking resistance due to the high surface crystallinity (hardness) and low xylene solubles. Examples of suitable high crystalline polypropylene resins (HCPP) include but are not limited to Total Petrochemical grade 3270 and Phillips 66 grade CH020XKX.

Polybutene-1 (PB-1) copolymers at an amount of <25 wt % in the prior art was found not only to improve the stretchability (processing aid) but also improve the releasability of a release layer due to its unique physical properties. PB-1 copolymer is also a compatibilizer of PMP and PP homopolymers so that it improves the lamination bond strength between the PMP outer layer and PP core layer. PB-1 copolymers melt at temperatures lower than the melting point of PMP and HCPP. As a result of similarity in structure, PB-1, PMP, and HCPP are compatible; a desirable amount of PB-1 polymers could be well dispersed in the PMP and HCPP matrix. BP-1 polymers in molten state lubricate the stretching of PMP and HCPP crystals during orientation. The stretching temperature of the coextruded film is higher than the Tm of BP-1 polymers but lower than the Tm of PMP and HCPP crystals. After orientation, PMP and HCPP crystallize at higher temperatures, followed by BP-1 crystallizing in the amorphous phase of HCPP skin layer as cooling continues. Without being bound by any theory, as a result of this factor, BP-1 crystal islands are well-dispersed inside the amorphous phase of PMP release layer and have a tendency to reduce blocking to the surface of adhesives, molding tools, and molded parts.

Examples of suitable PB-1 polymers include but are not limited to the ethylene-containing PB-1 polymers Toppyl™ PB8640M and PB8340M commercialized by LyondellBasell, and those copolymers of butane-1 and alpha-olefin e.g. Tafmer™ BL2481M and ethylene-containing PB-1 polymers, e.g. Tafmer™ A4085S commercialized by Mitsui Chemicals.

Aside from PB-1 copolymers, ethylene-propylene copolymer (EP copolymer or propylene copolymers), ionomers or maleic anhydride modified polar polyolefin are suitable to be incorporated into the outer PMP release layer to improve processability and to modify adhesion affinity of the outer PMP release layer. Examples of suitable EP copolymers include ExxonMobil's Vistamaxx™ 3588, Total Petrochemicals PPR 8473 and LX5 17-21. Those suitable EP copolymers have a melting temperature in the range of 50 to 140° C., preferably, 100 to 140° C.; and a MFR of 1 to 30 g/10 min., preferably, 3 to 12 g/10 min. Maleic anhydride modified polar polyolefin resins include but are not limited to Mitsui Admer® QF500A. Other grafted polar polyolefins or copolymerized polar polyolefin resins could be added into the outer layers to promote adhesion affinity as it is necessary.

It is well-known to those skilled in the art, that there is a need to add inorganic or organic anti-blocking agents into the outer skin layers to improve processability in film-making and handling. Anti-blocking and slip agents are extremely important to reduce blocking force and COF. Low and stable COF is required for achieving good machinability of a release film. It is desirable that the dynamic COF of the outer PMP release layer containing a release film is in the range of from 0.20 to 0.35 to provide good machinability in the downstream processes. A desirable amount of anti-blocking agents may be added up to 50,000 ppm to the outer layers, depending on their functionality, preferably 300-30,000 ppm of anti-blocking agents may be added.

Examples of suitable anti-blocking and slip agents for the outer layer are those having smooth surface, low surface energy, and low tendency to transfer and stick to the adhesive layer or receptive layer, including spherical silica particles (SiO2), Silton® antiblocks (e.g. Silton® JC20 and JC 30 particles of a spherical sodium calcium aluminum silicate (“silicate”), and cross-linked silicone particles (Tospearl® particles), Preferably, the particle sizes are in the range of from 2 to 5 microns.

Suitable anti-blocking and slip agents also include partially crosslinked polydialkylsiloxane particles, which have irregular particle surface, low surface energy and non-flowable physical property. The potential silicone oligomer residues inside the partially cross-linked particles are greatly confined in the particles so that the content of mobile silicone oligomers is not substantially detrimental to the functionalities of the outer functional layers. The partially cross-linked polydialkylsiloxane particles have the slip attribute of silicone oil but do not have the tendency to transfer or migrate to the top surface of adhesive layer or receptive substrate. Preferably, the particle sizes are controlled in the range of 0.5 to 10 microns, more preferably in the range of from 0.5 to 4 microns. The content of partially crosslinked polyalkylsiloxane is preferably in the range of from 0.1 to 5 wt %, more preferably, in the range of from 0.1 to 5 wt %. Examples of those partially cross-linked silicone gum include EverGlide™ MB-125-11 Ultra provided by Polymer Dynamix and HMB-6301 provided by Dow Corning. Both products have a 25 wt % active component in a PP carrier resin.

An optional but desirable amount of fluoropolymer additive can be included in the outer layers to improve the distribution of additives and prevent extrusion die lip buildup. The content of the fluoropolymer additive is in the range of about 100-1000 ppm of the core layer, preferably 300-600 ppm of the outer layer. The fluoropolymer is well known in the prior art as a processing aid commercially available in a masterbatch form.

The core layer (B) of the coextruded laminate film essentially comprises semi-crystalline propylene homopolymers. Examples of suitable homo-polypropylene resins include Total Petrochemical grades 3270, 3271, 3272, and 3273; Phillipps 66 grades CH016, CH020-01, and CH020XKX. Typically, these polypropylene resins have a melt flow rate in the range of from 1.5 to 3.5 g/10 min., a melting point in the range of from 160-167° C., xylene solubles of <3 wt %, and a density of about 0.90-0.92 g/cm³.

The coextruded outer skin layer (C) designed for functionalities could be optionally formulated from thermoplastic polyolefin resins for the application of release (in a case of a two-sided release film), heat-sealing, winding, adhesion, or printing. The polyolefin resins include ethylene homopolymer, propylene homopolymer, ethylene or propylene-based copolymers and terpolymers (e.g. ethylene-propylene, ethylene-butene, propylene-butene, ethylene-propylene-butene), or the blends thereof. Modified polar polyolefin resins for instance as maleic anhydride grafted polar polyolefins or copolymerized polar polyolefin resins could be added into the outer layers to promote adhesion, particularly as a tie-resin or tie-layer for receiving polar polymer coatings or coextruded layers.

In some embodiments, one surface layer containing the two sided PMP release film could be treated to a desired surface energy extent to differentiate the surface energy of polymers and molecules on the top surface for modifying the release capability and adhesion affinity to the surface of an adhesive layer, molded parts or molding tools. Surface treatments can be conducted by using the high densities of energy flux, for example, corona, plasma, flame, and ion-electron beam treatment. Surface treatments effectively create surface charges, ionic species or small molecule species on the top surface of PMP release layer, resulting in enhancement in adhesion affinity. However, it is noted that overtreatment can cause severe blocking issue.

Another desirable method of controlling the adhesion affinity of two-sided PMP release film is to modify the material compositions of the two respective outer PMP release layers by differentiating the PMP content in each outer PMP release layer or by adding additives with different surface energies; for instance, incorporating ionomers or grafting modified polar polyolefins to promote or reduce the adhesion affinity or releasability of each outer PMP release layer.

For a typical 3-layer coextruded film embodiment (A/B/C) as described previously, the coextrusion process includes a three-layered compositing die. The polymeric core layer (B) is sandwiched between the two outer skin layers (A) and (C). Depending on the design of film structure, the first outer PMP release layer can be either on the cast (drum) side or air knife side. Either the first PMP outer layer (A) or the second outer layer (C) of three layer laminate sheet is cast onto a chilling (or casting) drum with a controlled temperature in the range of from about 15 to 45° C. to solidify the non-oriented laminate sheet, followed by a secondary cooling on another chilling drum with a controlled temperature. The non-oriented laminate sheet is then stretched in the machine direction at temperatures about 95 to 165° C. at a ratio of about 4× to 6× times of the original length and then heat set at about 50 to 100° C. to obtain a uniaxially oriented laminate sheet with minimal thermal shrinkage. The uniaxially oriented laminate sheet is introduced into a tenter and preliminarily heated between about 130° C. and 180° C., and stretched in the transverse direction at a ratio of about 6× to 10× times of the original length and then heat-set to give a biaxially oriented sheet with minimal thermal shrinkage. Surface treatment discussed above may be applied to either layer (A) or layer (C) or both at a desirable level of energy output before rewinding the film, depending on the film product design.

The total thickness of the PMP release film after biaxial orientation could be in the range of from 10 to 100 microns, preferably 10 to 75 microns, more preferably 10 to 50 microns. The thickness of the most outer layers could be in the range of from 0.25 to 5 microns, preferably 0.5 to 3 microns, and more preferably 0.5 to 2.0 microns.

The PMP release film may then be used for carrying PSA adhesives on the opposite side of the release layer as designed as one-side release film. The printed film may be laminated with a metallized barrier film which could be a metallized BOPP film or polyester film with an adhesive receptive layer opposite to the metal coating layer. After lamination, a cold seal adhesive could be coated on the substrate's receptive layer surface; the adhesive is dried at elevated temperatures; and then the web is rewound into a roll. The surface of the cold seal adhesive layer directly contacts the surface of the release layer, which is opposite to the adhesive layer. The processes of printing, laminating, coating could be conducted inline or offline. The rewound roll then needs to be easily unwound, without blocking, in downstream sub-slitting process. The slit rolls will be unwound to use at end-user locations using a special designed process.

“Free of silicone” has been a term that presents in the product requirement of some specific end-users for the purpose of preventing unwanted silicone contamination. Release liners such as silicone-coated paper and silicone-coated BOPP or BOPET films can contain a large amount of residual silicone in the release layer that can readily transfer to the surface of end-user products and articles afterwards. In prior art release liners, silicone is intentionally included into the release layer containing those silicone coated liners for providing slip or release functionalities.

In some embodiments, the outer PMP release layer containing is “free of silicone,” meaning that the polymers in the release layer do not include silicone that is free to leach out of the release layer, but may include silicone as a minor impurity or an additive that does not leach out of the release layer, for instance, Tospearl™ anti-blocking particles that are crosslinked polysiloxane and therefore the silicone in the crosslinked polysiloxane does not leach out of the release layer. Specifically, “free of silicone” refers to polydimethylsiloxane (PDMS) moieties that are present upon the surface of the layer and are free to migrate or transfer to other respective layers' surfaces.

In some embodiments, the outer PMP release layer as well as the whole structure of the PMP release film is “completely free of silicone,” suggesting that there is no silicone included in the polymer composition. The PMP release film could be formulated into a release film which is either “free of silicone” or “completely free of silicone” by adjusting the COF control additives e.g. antiblocks or slip additives.

Recycling is not only a method to reduce product cost but also a method to potentially reduce the environmental impact through a low carbon footprint business model. A PMP release film comprises a blend of PMP or PMP copolymer, polypropylene, polybutene-1 copolymers, and polypropylene copolymers. Recyclable materials include both the trims and scrap generated in film making process of the PMP release film (internal recycling process), and the post-consumer recycled PMP release film (external recycling process), which can be ground into flakes and then melt extruded using a single screw or twin screw extruder, subsequently pelletized into pellets for reuse in film making. The polybutene-1 copolymers and propylene copolymers in the structure of the PMP release film work as compatibilizers between PMP and PP resins so that the PMP resin in the PMP release layer or intermediate can be well dispersed into the polymer matrix. No gel particles are formed in the polymer matrix as there are no crosslinked materials in the system, while crosslinked materials are usually part of silicone coated BOPP or silicone coated PET films. Such processes not only reduce production costs but also are feasible for the commercial approaches of a low carbon footprint for that there exist technical viability issues.

The embodiments could be better understood with reference to the following examples, which are intended to illustrate specific embodiments within the overall scope of the invention.

### Materials Description

Total Petrochemical Co.'s grade 3272, which is homo-polypropylene (homoPP) having a melt flow rate (MFR) of about 2 g/10 min., a melting temperature (Tm) of 163° C. and a xylene solubles (XS) of about 3%.

Phillips 66 CH020XKX is high crystalline polypropylene (HCPP) homopolymer having a MFR of 2 g/10 min., a Tm of 164° C. and a XS of about 2%.

Total 3576XHD, which is a compound of 99.5 wt % Total 3571 and 0.5 wt % Silton® JC-30 antiblock (Silton® JC 30 is an anti-blocking agent with nominal 3 μm particle size of a spherical sodium calcium aluminum silicate manufactured by Mizusawa Industrial Chemicals, Co., Ltd.).

Total LX11203 is a mini-random polypropylene resin with an ethylene content in the range of 0.4 mole % to 0.8 mole %, having a melt flow index of 3.5 g/10 min. and a Tm of 157° C.

Total 3571 is a homo-polypropylene having a MFR of 9.0 g/10 min., and a Tm of 160° C., and a XS of about 3%.

Ampacet 402810 is a processing aid in the masterbatch and contains 5 wt % active fluoropolymer in EP copolymer as a carrier resin.

TPX™ MX002, polymethylpentene homopolymer, is commercially provided by Mitsui Chemicals, which has a Tm of 224° C., a crystallization temperature (Tc) of 209° C., and a MFR of 21 g/10 min (measured under 5.0 Kg load and 260° C.).

Absortomer™ EP-1013, a copolymer of 1-methyl-1-pentene and α-olefin monomer, provided by Mitsui Chemicals, it has a Tm of 130° C. and a MFR of 10 g/10 min., and a Tg of 40° C.

Tafmer™ BL2481M, butane-1 based copolymer, is commercially provided by Mitsui Chemicals, having a Tm of 58° C. and a MFR of 9 g/10 min.

EverGlide® MB4450 is available from Polymer Dynamix, it is a compound of 50 wt % TPX™ MX002 and 50 wt % partially crosslinked polydimethylsiloxane polymer.

EverGlide® MB125-11 is commercially provided by Polymer Dynamix, it is a compound of 25 wt % partially crosslinked polydimethylsiloxane and 75 wt % homopolypropylene.

Polybatch™ ABVT 242 SC is commercially provided by A Schulman, it is the masterbatch of 5% Tospearl® 120 particles in polypropylene copolymer carrier resin. Tospearl® 120 has a nominal 2 μm particle size in a spherical shape, it is completely cross-linked silicone polymer supplied by Momentive Performance Materials.

The COSEAL™ 30061A, provided by Dow Chemicals, is a cold seal adhesive, it is water-based milky white synthetic latex adhesive with a solids content of 59.1±1%.

RAD-BOND 12PS12LVFB is a waterborne UV curable pressure sensitive adhesive provided by Actega WIT, Inc.

### EXAMPLES

### Example 1

Example 1 represents a comparative example to describe the experimental conditions of making the same. A 3-layer coextruded PMP release film was made on a nominal 1.6 m wide biaxial orientation line, comprising a core layer (B), a first outer PMP release layer (A) on one side of the core layer, and a second outer functional layer (C) on the other side of the core layer opposite that of the first outer layer (A). The core layer comprises about 100 wt % Total 3272 homo-polypropylene. The outer PMP release layer (shown in Table 1) comprised a blend of 87.5 wt % TPX™ MX002, and 9 wt % Tafmer™ BL2481M, and 2.5 wt % EverGlide® MB4450, and 1 wt % of Ampacet 402810. The outer layer C comprised a blend of 98% Total 3272 and 2 wt % Total 3576XHD.

The content of components used in the outer PMP release layer in Examples 1-19 is showed in Table 1.

TABLE 1

| | Outer | | | | | | | | |
|---|---|---|---|---|---|---|---|---|---|
| | release | Recipes of outer release layer (all components in wt %) | | | | | | | |
| Example | layer | MX002 | EP-1013 | BL2481M | MB4450 | 402810 | MB125-11 | ABVT242SC | CH020XKX |
| 1 | A | 87.5 | | 9 | 2.5 | 1 | | | |
| 2 | A | 82.5 | | 9 | 7.5 | 1 | | | |
| 3 | A | 84 | | 9 | | 1 | 6 | | |
| 4 | A | 80 | | 9 | | 1 | 10 | | |
| 5 | A | 67.7 | | 10 | 6 | 0.3 | | 6 | 10 |
| 6 | A | 73.6 | | 10 | 10 | 0.3 | | 6 | |
| 7 | A | 73.6 | | 10 | 10 | 0.3 | | 6 | |
| 8 | A | 73.6 | | 10 | 10 | 0.3 | | 6 | |
| 9 | A & C | 81.7 | | 10 | | 0.3 | | 8 | |
| 10 | A & C | 81.7 | | 10 | | 0.3 | | 8 | |
| 11 | A & C | 79.7 | | 10 | 4 | 0.3 | | 6 | |
| 12 | A & C | 79.7 | | 10 | 4 | 0.3 | | 6 | |
| 13 | A & C | 77 | | 10 | 6 | 1 | | 6 | |
| 14 | A & C | 77 | | 10 | 6 | 1 | | 6 | |
| 15 | A & C | 77 | | 10 | 6 | 1 | | 6 | |
| 16 | C | | | | | | | | 100 |
| 17 | C | | 100 | | | | | | |
| 18 | C | | 92 | | | | 8 | | |
| 19 | C | | 90 | | | | 5 | 5 | |

Table 1.1 shows the composition of the multilayer film of Example 1 with the first column showing the composition according to the tradenames and the second column showing the composition by chemical ingredients.

TABLE 1.1

| | |
|---|---|
| Outer Layer A: Blend of 87.5 wt % | 88.75 wt % PMP |
| TPX ™ MX002, and 9 wt % | 9 wt % butane-1 |
| Tafmer ™ BL2481M, and 2.5 wt % | copolymer |
| EverGlide ® MB4450 | 1.25 wt % PDMS |
| (50 wt % TPX ™ MX002 and | 0.05 wt % fluoropolymer |
| 50 wt % partially crosslinked | 0.95 wt % EP copolymer |
| polydimethylsiloxane polymer), | |
| and 1 wt % of Ampacet 402810 | |
| Core Layer B: 100 wt % Total 3272 homo- | 100 wt % PP |
| polypropylene | |
| Outer Layer C: Blend of 98% | 99.99 wt % PP |
| Total 3272 and 2 wt % Total 3576XHD | 0.01 wt % silicate |
| (99.5 wt % Total 3571 and 0.5 | |
| wt % Silton ® JC-30 antiblock | |
| (“silicate”) | |

The total thickness of this 3-layer coextruded film after biaxial orientation was nominal 120 G (30.0 μm). The thickness of the outer PMP skin layer (A) and outer skin layer (C) after biaxial orientation was the nominal 10 G (2.5 μm) and 4 G (1.0 μm), respectively. The thickness of the core layer (B) was nominal 106 G (26.5 μm). The outer PMP release layer (A) was melt-extruded at temperature about 250 to 280° C. The core layer and outer skin layer (C) were melt-extruded at temperature about 230-260° C. The 3-layer coextrudate was passed through a flat die, and the melt polymer curtain was cast on a chill drum of about 20-26° C. at a speed of 15.3 feet/min. The outer layer (A) was on the side of casting drum. The formed cast sheet was passed through a series of heated rolls at about 100-150° C. with differential speeds to stretch in the machine direction (MD) to a 4.75 stretch ratio, followed by transverse direction (TD) stretching to an 8.0 stretch ratio in the tenter oven at about 150-170° C. in a tenter oven. Inside the tenter oven, there are three zones for the purposes of heating, stretching and heat setting. The temperatures of first, second and third zones are about 180, 165 and 155° C., respectively. After transverse stretching, the film was heat-set in the third zone to minimize thermal shrinkage, followed by a 10% relax in the transverse direction. The resultant laminate film was corona discharge-treated upon the surface of the outer skin layer (C) before it was wound into a roll form. The energy output for corona discharge-treatment was about 1.0 KW (1.0 kilowatts: 100% output level) which is desirable for the homo-polypropylene outer layer to reach a surface energy level of 38 to 42 dyne/cm (measured as wetting tension). The film was then tested for basic physical properties and release performance.

Similar to Table 1.1, Table 1.2 to Table 1.13 show the compositions of the multilayer films of Examples 2-19 with the first column showing the composition according to the tradenames and the second column showing the composition by chemical ingredients.

### Example 2

Example 2 was made using the same conditions as that of Example 1. The outer PMP release layer was changed to comprising a blend of 82.5 wt % TPX™ MX002, and 9 wt % Tafmer™ BL2481M, and 7.5 wt % EverGlide® MB4450, and 1 wt % Ampacet 402810 as shown in Table 1.2.

TABLE 1.2

| | |
|---|---|
| Outer Layer A: Blend of 82.5 wt % TPX ™ | 86.25 wt % PMP |
| MX002, and 9 wt % Tafmer ™ BL2481M, | 9 wt % butane-1 copolymer |
| and 7.5 wt % EverGlide ® MB4450 | 3.75 wt % PDMS |
| (50 wt % TPX ™ MX002 and 50 wt % | 0.05 wt % fluoropolymer |
| partially crosslinked polydimethylsiloxane | 0.95 wt % EP copolymer |
| polymer), and 1 wt % of Ampacet 402810 | |
| Core Layer B: 100 wt % Total 3272 homo- | 100 wt % PP |
| polypropylene | |
| Outer Layer C: Blend of 98% Total | 99.99 wt % PP |
| 3272 and 2 wt % Total 3576XHD | 0.01 wt % silicate |
| (99.5 wt % Total 3571 and 0.5 | |
| wt % Silton ® JC-30 antiblock (“silicate”) | |

### Example 3

Example 3 was made using the same conditions as that of Example 1. The outer PMP release layer was changed to comprising a blend of 84 wt % TPX™ MX002, and 9 wt % Tafmer™ BL2481M, and 6 wt % EverGlide® MB125-11, and 1 wt % Ampacet 402810 as shown in Table 1.3.

TABLE 1.3

| | |
|---|---|
| Outer Layer A: Blend of 84 wt % | 84 wt % PMP |
| TPX ™ MX002, and 9 wt % | 9 wt % butane-1 |
| Tafmer ™ BL2481M, and 6 wt % | copolymer |
| EverGlide ® MB125-11 | 1.5 wt % PDMS |
| (25 wt % partially crosslinked | 4.5 wt % Homo-PP |
| polydimethylsiloxane and 75 wt % | 0.05 wt % fluoropolymer |
| homopolypropylene), and 1 wt % | 0.95 wt % EP copolymer |
| of Ampacet 402810 | |
| Core Layer B: 100 wt % Total 3272 homo- | 100 wt % PP |
| polypropylene | |
| Outer Layer C: Blend of 98% Total | 99.99 wt % PP |
| 3272 and 2 wt % Total 3576XHD | 0.01 wt % silicate |
| (99.5 wt % Total 3571 and 0.5 wt % | |
| Silton ® JC-30 antiblock (“silicate”) | |

### Example 4

Example 4 was made using the same conditions as that of Example 1. The outer PMP release layer was changed to comprising a blend of 80 wt % TPX™ MX002, and 9 wt % Tafmer™ BL2481M, and 10 wt % EverGlide® MB125-11, and 1 wt % Ampacet 402810 as shown in Table 1.4.

TABLE 1.4

| | |
|---|---|
| Outer Layer A: Blend of 80 wt % TPX ™ | 80 wt % PMP |
| MX002, and 9 wt % Tafmer ™ BL2481M, | 9 wt % butane-1 copolymer |
| and 10 wt % EverGlide ® MB125-11 (25 wt | 2.5 wt % PDMS |
| % partially crosslinked | 7.5 wt % Homo-PP |
| polydimethylsiloxane and 75 wt % | 0.05 wt % fluoropolymer |
| homopolypropylene), and 1 wt % of | 0.95 wt % EP copolymer |
| Ampacet 402810 | |
| Core Layer B: 100 wt % Total 3272 homo- | 100 wt % PP |
| polypropylene | |
| Outer Layer C: Blend of 98% Total 3272 | 99.99 wt % PP |
| and 2 wt % Total 3576XHD (99.5 wt % | 0.01 wt % silicate |
| Total 3571 and 0.5 wt % Silton ® JC-30 | |
| antiblock (“silicate”) | |

### Example 5

Example 5 was made using the same conditions as that of Example 1. The outer PMP release layer was changed to comprising a blend of 67.7 wt % TPX™ MX002, and 10 wt % Tafmer™ BL2481M, and 6 wt % EverGlide® MB4450, 6 wt % Polybatch™ ABVT 242 SC, 10 wt % CH020XKX, and 0.3 wt % Ampacet 402810 as shown in Table 1.5.

TABLE 1.5

| | |
|---|---|
| Outer Layer A: Blend of 67.7 wt % | 83 wt % PMP |
| TPX ™ MX002, and 10 wt % Tafmer ™ | 9 wt % butane-1 copolymer |
| BL2481M, and 6 wt % EverGlide ® | 3 wt % PDMS |
| M1B4450 (50 wt % TPX ™ MX002 and 50 | 0.4 wt % completely |
| wt % partially crosslinked | cross-linked |
| polydimethylsiloxane polymer), 6 wt % | silicone polymer particles |
| Polybatch ™ ABVT 242 Sc, 10 wt % | 7.6 wt %PP copolymer |
| CH020XKX and 0.3 wt % of Ampacet | 10 wt % HCPP |
| 402810 | 0.015 wt % fluoropolymer |
| | 0.985 wt % EP copolymer |
| Core Layer B: 100 wt % Total 3272 | 100 wt % PP |
| homo-polypropylene | |
| Outer Layer C: Blend of 98% Total 3272 | 99.99 wt % PP |
| and 2 wt % Total 3576XHD (99.5 wt % | 0.01 wt % silicate |
| Total 3571 and 0.5 wt % Silton ® JC-30 | |
| antiblock (“silicate”) | |

The outer layer (A) of films made in Examples 1 to 5 was tested for wetting tension, COF, tape peeling force, delamination bond, and cold seal release force. The test results were shown in Table 2.

TABLE 2

| | | | | | | | | | | CSA |
|---|---|---|---|---|---|---|---|---|---|---|
| | | Corona | | | | | | Delam. bond | | release |
| | Release | energy | Wett. Ten. | COF, A/A | | Tape peeling force | | Force | Fail. | Force (g/in) |
| Example | layer | output | (dyne/cm) | μs | μd | (g/in) | Fail. mode | (g/in) | mode | (22° C.) |
| Ex. 1 | A | 0 | 19.9 | 0.56 | 0.53 | 284 | Tape Destructed | 35 | A/Core | 42 |
| Ex. 2 | A | 0 | 20.5 | 0.22 | 0.20 | 914 | Tape Destructed | 63 | A/Core | 29 |
| Ex. 3 | A | 0 | 18.7 | 0.31 | 0.29 | 816 | Tape Destructed | 49 | A/Core | 31 |
| Ex. 4 | A | 0 | 18.1 | 0.28 | 0.25 | 855 | Tape Destructed | 120 | A/Core | 39 |
| Ex. 5 | A | 0 | 18.7 | 0.25 | 0.22 | | | 573 | Tape/A | 31 |

Without corona discharge-treatment applied to the outer layer, all samples showed comparable surface energy in the range of 18.1 to 20.5 measured by using contact angle method. The samples showed low COF, low cold seal release force under ambient condition, and high tape peeling force. However, the delamination bond of Examples 1 to 3 is lower than 100 g/in, which is not desirable for some downstream application. The delamination bond of Examples 4 to 5 was improved to a desirable value for downstream processing since the higher content in homo-polypropylene and propylene copolymer added as the carrier resins in the masterbatches of antiblock and slip agents.

### Examples 6-8

Examples 6-8 were made using the same conditions as that of Example 1. The outer PMP release layer was changed to comprising a blend of 73.6 wt % TPX™ MX002, and 10 wt % Tafmer™ BL2481M, and 10 wt % EverGlide® MB4450, and 6 wt % Polybatch™ ABVT 242 SC, and 0.3 wt % Ampacet 402810 as shown in Table 1.6. There was no change for the core layer (B) and the outer layer (C).

The outer PMP release layer (A) was corona discharge-treated at a different energy output level of 0%, 10% and 100%, respectively.

TABLE 1.6

| | |
|---|---|
| Outer Layer A: Blend of 73.6 wt % | 78.6 wt % PMP |
| TPX ™ MX002, and 10 wt % | 10 wt % butane-1 |
| Tafmer ™ BL2481M, and 10 wt % | copolymer 5 wt % PDMS |
| EverGlide ® MB4450 (50 wt % TPX ™ | 0.3 wt % of completely |
| MX002 and 50 wt % partially crosslinked | cross-linked |
| polydimethylsiloxane polymer), 6 wt % | silicone polymer particles |
| Polybatch ™ ABVT 242 Sc and 0.3 | in 5.7 wt % PP copolymer |
| wt % of Ampacet 402810 | 0.015 wt % fluoropolymer |
| | 0.985 wt % EP copolymer |
| Core Layer B: 100 wt % Total 3272 homo- | 100 wt % PP |
| polypropylene | |
| Outer Layer C: Blend of 98% Total | 99.99 wt % PP |
| 3272 and 2 wt % Total 3576XHD | 0.01 wt % silicate |
| (99.5 wt % Total 3571 and 0.5 | |
| wt % Silton ® JC-30 antiblock (“silicate”) | |

The outer PMP release layer (A) was corona discharge-treated at a different energy output level of 0%, 10% and 100%, respectively. The energy output 1.0 KW is considered as a scale of 100% treatment for the film-making conditions described previously to reach a surface energy level of 38 to 42 dyne/cm which is capable to provide excellent printability or coating adhesion for the surface of a BOPP film. PMP release film samples were collected after a differentiated surface discharge-treatment.

The outer PMP release layer (A) of the films made in Examples 6 to 8 was tested wetting tension, COF, and cold seal release force. The test results were shown in Table 3.

TABLE 3

| | | Corona | | | | CSA release |
|---|---|---|---|---|---|---|
| | Release | energy | Wett. Ten. | COF, A/A | | Force (g/in) |
| Example | layer | output | (dyne/cm) | μs | μd | (22° C.) |
| Ex. 6 | A | 0 | 18.1 | 0.27 | 0.23 | 26 |
| Ex. 7 | A | 10% | 19.3 | 0.30 | 0.26 | 62 |
| Ex. 8 | A | 100% | 22.3 | 0.30 | 0.23 | 126 |

With a differentiated corona discharge-treatment energy output applied to the outer layer which has the same composition, the surface energy (wetting tension) increased with increasing the output of corona discharge-treatment. The cold seal release force under ambient condition increased with increasing output energy from corona discharge-treatment. Corona discharge-treatment on the outer layer differentiated the adhesion affinity and release properties of the release film. However, corona treatment did not impact the COF of the outer layer.

### Examples 9-10

Examples 9-10 were made using the same conditions as that of Example 1. However, the outer PMP release layers (A) and (C) have the same compositions, a blend of 81.7 wt % TPX™ MX002, and 10 wt % Tafmer™ BL2481M, and 8 wt % Polybatch™ ABVT 242 SC, and 0.3 wt % Ampacet 402810 as shown in Table 1.7. The outer PMP layers were extruded at the same extrusion temperature as that used in Example 1. There was no change for the core layer (B). No surface treatment was applied to the outer PMP release layer (A), while the outer PMP release layer (C) was corona discharge-treated at 100% energy output in Example 9.

For Example 10, the outer PMP release layers (A) and (C) were both corona discharge-treated at an energy output 100% (1.0 KW/each side).

TABLE 1.7

| | |
|---|---|
| Outer Layer A: Blend of 81.7 wt % | 81.7 wt % PMP |
| TPX ™ MX002, and 10 wt % Tafmer ™ | 10 wt % butane-1 copolymer |
| BL2481M, 8 wt % Polybatch ™ ABVT | 0.4 wt % completely |
| 242 SC and 0.3 wt % of Ampacet 402810 | cross-linked |
| | silicone polymer particles |
| | 7.6 wt % PP copolymer |
| | 0.015 wt % fluoropolymer |
| | 0.985 wt % EP copolymer |
| Core Layer B: 100 wt % Total 3272 | 100 wt % PP |
| homo-polypropylene | |
| Outer Layer C: Blend of 81.7 wt % | 81.7 wt % PMP |
| TPX ™ MX002, and 10 wt % Tafmer ™ | 10 wt % butane-1 copolymer |
| BL2481M, 8 wt % Polybatch ™ ABVT | 0.4 wt % completely |
| 242 SC and 0.3 wt % of Ampacet 402810 | cross-linked |
| | silicone polymer particles |
| | 7.6 wt % PP copolymer |
| | 0.015 wt % fluoropolymer |
| | 0.985 wt % EP copolymer |

### Examples 11-12

Examples 11-12 were made using the same conditions as that of Examples 9-10. However, the outer PMP release layers comprised a blend of 79.7 wt % TPX™ MX002, and 10 wt % Tafmer™ BL2481M, and 4 wt % EverGlide® MB4450, and 6 wt % Polybatch™ ABVT 242 SC, and 0.3 wt % Ampacet 402810 as shown in Table 1.8. The outer layer (C) had the same compositions and thickness as the outer layer (A). There was no change for the core layer (B). No surface treatment was applied to the outer PMP release layer (A) of the film made in Example 11, the outer release layer (C) was surface treated by corona-discharge at an energy output 100% (1.0 KW/each side). For Example 12, the outer PMP release layers (A) and (C) were both corona discharge-treated at an energy output 100% (1.0 KW/each side).

TABLE 1.8

| | |
|---|---|
| Outer Layer A: Blend of 79.7 wt % TPX ™ | 81.7 wt % PMP |
| MX002, and 10 wt % Tafmer ™ BL2481M, | 10 wt % butane-1 |
| and 4 wt % EverGlide ® MB4450 6 wt % | copolymer |
| Polybatch ™ ABVT 242 SC and 0.3 wt % of | 2 wt % PDMS |
| Ampacet 402810 | 0.3 wt % completely |
| | cross-linked |
| | silicone polymer particles |
| | 5.7 wt %PP copolymer |
| | 0.015 wt % fluoropolymer |
| | 0.985 wt % EP copolymer |
| Core Layer B: 100 wt % Total 3272 homo- | 100 wt % PP |
| polypropylene | |
| Outer Layer C: Blend of 79.7 wt % TPX ™ | 81.7 wt % PMP |
| MX002, and 10 wt % Tafmer ™ BL2481M, | 10 wt % butane-1 |
| and 4 wt % EverGlide ® MB4450 6 wt % | copolymer |
| Polybatch ™ ABVT 242 SC and 0.3 wt % of | 2 wt % PDMS |
| Ampacet 402810 | 0.3 wt % completely |
| | cross-linked |
| | silicone polymer particles |
| | 5.7 wt %PP copolymer |
| | 0.015 wt % fluoropolymer |
| | 0.985 wt % EP copolymer |

The coextruded oriented polyolefin release films made in Examples 9 to 12 comprised two outer layers. The outer layer (C) had the same compositions as that of the outer (A). The outer layer (A) of the films was tested for wetting tension, COF, delamination bond, and cold seal release force. The test results are shown in Table 4.

TABLE 4

| | | Corona | | | | | | CSA release fore (g/in) | |
|---|---|---|---|---|---|---|---|---|---|
| | Release | energy | Wett. Ten. | COF, A/A | | Delam. bond | | Ambient | Heat aged |
| Example | layer | output | (dyne/cm) | μs | μd | Force (g/in) | Fail. mode | (22° C.) | (50° C.) |
| Ex. 9 | A | 0 | 19.3 | 0.31 | 0.25 | 122 | A/Core | 49.7 | 37 |
| Ex. 10 | A | 100% | 22.3 | 0.31 | 0.24 | 114 | A/Core | 121.3 | Blocked |
| Ex. 11 | A | 0 | 18.1 | 0.26 | 0.22 | 121 | A/Core | 35.3 | 36 |
| Ex. 12 | A | 100% | 20.5 | 0.29 | 0.24 | 80 | A/Core | 136.0 | Blocked |

For the outer layer (A) in Examples 9 to 12, corona discharge-treatment was applied to the outer layer (A) of the Examples 10 and 12 at a 100% energy output. The outer layer (A) of Examples 9 and 11 was not corona discharge-treated. The treatment increased the wetting tension of the outer layers. The wetting tension of the treated outer layer (A) are higher than that of those not treated. Although the corona treatment did not significantly change the wetting tension based upon the data of water-drop contact angle measurement, the treated outer layers of the films in Examples 10 and 12 showed much higher release force to the surface of cold seal adhesive. Under heat-aged condition, the treated outer layer (A) stuck to the surface of the adhesive layer (blocked) and could not be separated from each other without being deteriorated. The outer layers without corona discharge-treatment showed excellent low release force to the surface of adhesive layer under both ambient and heat-aged conditions. The outer layers also showed desirable low COF and delamination bond strength.

### Examples 13-15

Examples 13-15 were made on a nominal 3.2 m wide biaxial orientation line. The line had two extruders: one main extruder used for extruding the core layer (B); and one satellite extruder used for extruding the outer layers (A) and (C). The thickness—after biaxial orientation—of the outer layers (A) and (C) was set about the same at 10 G (2.5 μm). The thickness of the core layer (B) was 180 G (45 μm). The total thickness after biaxial orientation of the film samples was nominal 200 G (2 mils or 50 μm). The core layer (B) comprised about 100 wt % Total 3272 homo-polypropylene. The outer PMP release layers (A) and (C) comprised a blend of 77 wt % TPX™ MX002, and 10 wt % Tafmer™ BL2481M, and 6 wt % EverGlide® MB4450, 6 wt % Polybatch™ ABVT242SC, and 1 wt % of Ampacet 402810 as shown in Table 1.9.

TABLE 1.9

| | |
|---|---|
| Outer Layer A: Blend of 77 wt % TPX ™ | 80 wt % PMP |
| MX002, and 10 wt % Tafmer ™ | 10 wt % butane-1 |
| BL2481M, and 6 wt % EverGlide ® | copolymer 3 wt % PDMS |
| M1B4450 (50 wt % TPX ™ MX002 and 50 | 0.3 wt % completely |
| wt % partially crosslinked | cross-linked |
| polydimethylsiloxane polymer), 6 wt % | silicone polymer particles |
| Polybatch ™ ABVT 242 SC and 1 wt % of | 5.7 wt % PP copolymer |
| Ampacet 402810 | 0.05 wt % fluoropolymer |
| | 0.95 wt % EP copolymer |
| Core Layer B: 100 wt % Total 3272 | 100 wt % PP |
| homo-polypropylene | |
| Outer Layer C: Blend of 77 wt % TPX ™ | 80 wt % PMP |
| MX002, and 10 wt % Tafmer ™ | 10 wt % butane-1 |
| BL2481M, and 6 wt % EverGlide ® | copolymer 3 wt % PDMS |
| M1B4450 (50 wt % TPX ™ MX002 and 50 | 0.3 wt % completely |
| wt % partially crosslinked | cross-linked |
| polydimethylsiloxane polymer), 6 wt % | silicone polymer particles |
| Polybatch ™ ABVT 242 SC and 1 wt % of | 5.7 wt % PP copolymer |
| Ampacet 402810 | 0.05 wt % fluoropolymer |
| | 0.95 wt % EP copolymer |

The outer PMP release layers were melt-extruded at temperature about 270 to 280° C. The core layer was melt-extruded at temperature about 230-260° C. The 3-layer coextrudate was passed through a flat die, and the melt polymer curtain was cast on a chill drum of about 20-26° C. at a speed of 38 feet/min. The outer PMP release layer (A) was on the side of casting drum. The formed cast sheet was cooled in a water bath (temperature set at 21° C.) and then passed through a series of heated rolls at about 100-150° C. with differential speeds to stretch in the machine direction (MD) to a 4.5 stretch ratio. The line speed was 170 feet/min. This was followed by transverse direction (TD) stretching to an 8.0 stretch ratio in a tenter oven with temperatures set at about 150-170° C. After transverse stretching, the film was heat-set to minimize thermal shrinkage, followed by a 10% relax in the transverse direction. The resultant PMP release film was corona discharge-treated at an energy output level of 0%, 27%, and 50% (10.0 KW (kilowatts) was set for 100% output for this line), respectively, upon the surface of the outer PMP release layer (C) before it was wound into a roll form. No surface treatment was applied to the outer PMP release layer (A).

The PMP release films made in Examples 13 to 15 comprised two outer layers. The outer layer (C) has the same compositions as that of the outer (A). No corona discharge-treatment was applied to the outer layer (A) of the films made in Examples 13 to 15. The outer layer (C) of the films was tested for wetting tension (contact angle method), surface roughness (using Zygo Corporation surface profiler model 7300), COF, tape peeling force, cold seal release force, and release force using a UV curable pressure sensitive adhesive (PSA). The test results were shown in Table 5.

TABLE 5

| | | | | | | | | | CSA release | | |
|---|---|---|---|---|---|---|---|---|---|---|---|
| | | Corona | | | | | | | force (g/in) | PSA release force (g/in) | |
| | Release | energy | Wett. Ten. | Surf. Rough. | COF, C/C | | Tape peeling force | | Ambient | Ambient | Heat aged |
| Example | layer | output | (dyne/cm) | Ra (nm) | μs | μd | (g/in) | Fail. mode | (22° C.) | (22° C.) | (50° C.) |
| Ex. 13 | C | 0% | 12 | 260 | 0.20 | 0.17 | 782 | Tape/C | 24 | 22 | 370 |
| Ex. 14 | C | 27% | 17 | 144 | 0.44 | 0.41 | 556 | C/Core | 58 | 36 | 40 |
| Ex. 15 | C | 50% | 21.1 | 121 | 0.47 | 0.39 | 255 | C/Core | 65 | 49 | Blocked |

In Examples 13 to 15, corona discharge-treatment was applied to the outer layer (C) at energy output 0%, 27% and 50%, respectively. The outer layer (C) of Example 13 was not corona discharge-treated. The outer layer (C) of the film in Example 13 had a higher surface roughness and lower COF, compared to that of the films in Examples 14 and 15. The tape peeling force decreased significantly with decreasing surface roughness (due to increasing treatment energy output level). The failure mode was changed from “tape to the outer layer C” to “the outer layer C to the core layer”. The release force to the surface of the pre-cast cold seal adhesive layer increased with increasing output level of treatment energy. The release force to the surface of the pre-cast PSA adhesive layer also increased with increasing output level of treatment energy. Under heat-aged condition, the release force of the film in Example 13 was high due to severe anchoring resulted from its higher surface roughness. The outer layer (C) of the film in Example 14 showed excellent low release force to the surface of the pre-cast PSA adhesive layer under heat-aged condition, while the outer layer (C) of the film in Example 15 blocked due to its much higher surface energy (or high adhesion affinity to the surface of the pre-cast PSA adhesive layer). The results indicate that an outer layer with high surface energy is not desirable for the application under severe conditions such as high pressure and high temperature.

### Example 16

Example 16 was made using the same conditions as that of Example 1. However, the compositions were changed for both outer layers (A) and (C). The outer layer (A) was changed to comprising 100 wt % Total LX11203 mini-random polypropylene resin, the outer layer (C) was changed to comprising 100 wt % Phillips 66 CH020XKX resin as shown in Table 1.10. No change was applied to the core layer (B). The thickness of the outer layers (A) and (C) was set for 4 G (1.0 μm). The total thickness of the coextruded oriented laminate was 120 G (30.0 μm). The outer layer (A) was corona discharge-treated at an energy output 100% (1.0 KW) while no surface treatment was applied to the outer layer (C).

TABLE 1.10

| | |
|---|---|
| Outer Layer A: 100 wt % Total LX11203 | 100 wt % mini random |
| mini-random polypropylene resin | PP resin |
| Core Layer B: 100 wt % Total 3272 | 100 wt % PP |
| homo-polypropylene | |
| Outer Layer C: 100 wt % Phillips 66 | 100 wt % HCPP |
| CH020XKX resin | |

### Example 17

Example 17 was made using the same conditions as that of Example 16. No change was applied to the core layer (B) and the outer layer (A). However, the outer layer (C) was changed to comprising 100 wt % Absortomer™ EP-1013, a PMP copolymer as shown in Table 1.11.

TABLE 1.11

| | |
|---|---|
| Outer Layer A: 100 wt % Total LX11203 | 100 wt % mini random |
| mini-random polypropylene resin | PP resin |
| Core Layer B: 100 wt % Total 3272 | 100 wt % PP |
| homo-polypropylene | |
| Outer Layer C: 100 wt % Absortomer ™ | 100 wt % PMP copolymer |
| EP-1013, a PMP copolymer | |

### Example 18

Example 18 was made using the same conditions as that of Example 16. No change was applied to the core layer (B) and the outer layer (A). However, the outer layer (C) was changed to comprising a blend of 92 wt % Absortomer™ EP-1013, and 8 wt % EverGlide™ MB125-11 as shown in Table 1.12. The outer layer (C) was not corona discharge-treated while the outer layer (A) was treated.

TABLE 1.12

| | |
|---|---|
| Outer Layer A: 100 wt % Total LX11203 | 100 wt % mini random |
| mini-random polypropylene resin | PP resin |
| Core Layer B: 100 wt % Total 3272 | 100 wt % PP |
| homo-polypropylene | |
| Outer Layer C: blend of 92 wt % | 92 wt % PMP copolymer |
| Absortomer ™ EP-1013, and 8 wt % | 2 wt % PDMS |
| EverGlide ™ MB125-11 | 6 wt % Homo-PP |

### Example 19

Example 19 was made using the same conditions as that of Example 16. No change was applied to the core layer (B) and the outer layer (A). However, the outer layer (C) was changed to comprising a blend of 90 wt % Absortomer™ EP-1013 PMP copolymer, 5 wt % EverGlide™ MB125-11, and 5 wt % Polybatch™ ABVT242SC as shown in Table 1.13. The outer layer (C) was not corona discharge-treated while the outer layer (A) was discharge-treated.

TABLE 1.13

| | |
|---|---|
| Outer Layer A: 100 wt % Total LX11203 | 100 wt % mini random |
| mini-random polypropylene resin | PP resin |
| Core Layer B: 100 wt % Total 3272 homo- | 100 wt % PP |
| polypropylene | |
| Outer Layer C: 90 wt % Absortomer ™ EP- | 90 wt % PMP copolymer |
| 1013 PMP copolymer, 5 wt % EverGlide ™ | 1.25 wt % PDMS |
| MB125-11, and 5 wt % Polybatch ™ | 3.75 wt % Homo-PP |
| ABVT242SC | 0.25 wt % completely |
| | cross-linked silicone |
| | polymer particles 4.75 |
| | wt % PP copolymer |

The oriented polyolefin release films made in Examples 16 to 19 comprised one outer layer, one core layer, and one outer layer (A) with high adhesion affinity which was designed for printing, coating, or adhesion. The outer layer (C) had different compositions as that of the outer layer (A). The outer layer (A) was corona discharge-treated, while the outer layer (C) was not treated. The outer layer (C) of the films made in Examples 16 to 19 comprised different compositions to differentiate the “easy release” or “adhesion affinity”. The outer layer (C) of the films was tested for wetting tension (contact angle method), COF, tape peeling force, cold seal release force, and release force of UV curable pressure sensitive adhesive (PSA). The test results were shown in Table 6.

TABLE 6

| | | | | | | | | CSA release | | |
|---|---|---|---|---|---|---|---|---|---|---|
| | | Corona | | | | | | force (g/in) | PSA release force (g/in) | |
| | Release | energy | Wett. Ten. | COF, C/C | | Tape peeling force | | Ambient | Ambient | Heat aged |
| Example | layer | output | (dyne/cm) | μs | μd | (g/in) | Fail. mode | (22° C.) | (22° C.) | (50° C.) |
| Ex. 16 | C | 0 | 22.9 | 0.52 | 0.49 | | | 45 | Blocked | 544 |
| Ex. 17 | C | 0 | 20.5 | 1.77 | 1.51 | 972 | Tape destructed | 27 | 10 | 299 |
| Ex. 18 | C | 0 | 20.5 | 0.24 | 0.21 | 812 | Tape destructed | 22 | 15 | 545 |
| Ex. 19 | C | 0 | 18.1 | 0.36 | 0.30 | 942 | Tape destructed | 25 | 18 | 15 |

In Example 16, the outer layer (C) did not comprise anti-block and slip additives, resulting in high COF. The outer layer (C) showed good release to the surface of the pre-cast cold seal adhesive layer; however, it failed in the release force test to the surface of the pre-cast PSA adhesive layer under both ambient and heat-aged conditions.

In Example 17, the outer layer (C) comprised PMP copolymer only without anti-block and slip additives, resulting in extremely high COF. The outer layer (C) showed good lamination bond strength to the core layer based on the tape peeling test results, indicating that the PMP copolymer EP-1013 has good adhesion affinity to polypropylene. The release force is low under ambient condition to the surface of both the pre-cast cold seal adhesive layer and PSA adhesive layer. However, under heat-aged condition, the release force is high to the surface of the pre-cast PSA adhesive layer although it was released smoothly from the adhesive layer.

In Example 18, the outer layer (C) comprised PMP copolymer and slip additive, which is partially crosslinked polysiloxane, resulting in significantly lower COF. The outer layer (C) showed good lamination bond strength to the core layer (B) based on the tape peeling test results. The release force is low under ambient condition to the surface of both the pre-cast cold seal adhesive layer and PSA adhesive layer. However, under-heat aged condition, the release force is extremely high to the surface of pre-cast PSA adhesive layer, which is not feasible for the application with temperature sensitivity.

In Example 19, the outer layer (C) comprised PMP copolymer, anti-block and slip additives, resulting in significantly lower COF. The outer layer showed good lamination bond strength to the core layer (B). The release force is low under ambient condition to the surface of both the pre-cast cold seal adhesive layer and PSA adhesive layer. Under heat-aged condition, the release force is also extremely low to the surface of the pre-cast PSA adhesive layer (15 g/in), which is comparable to the release force of silicone-coated paper or silicone-coated BOPP film.

The compositions of the chemical ingredients in the first outer layer (Layer A), the core layer (Layer B) and the second outer layer (Layer C) in the multilayer films of Examples 1-19 are shown in Tables 7-9 in the Appendix.

### Test Methods

The various properties in the above examples were measured by the following methods:

### Free of Silicone Test

Presence of “free silicone” or polydimethylsiloxane (PDMS) upon the outer surface layer(s) of test films were conducted by using Time-of-Flight Secondary Ion Mass Spectroscopy (TOF-SIMS) analysis, using a Physical Electronics model TRIFT II. Data were obtained using a gallium liquid metal ion gun (LMIG) primary ion source. The instrument operated in an ion microprobe mode in which the bunched, pulsed primary ion beam was rastered across the sample's surface. Three positive ion and three negative ion spectra were obtained from each sample in order to confirm the reproducibility of the data. Acquisition of multiple spectra served to highlight possible chemical heterogeneity across the sample's surface. The data were collected within the static limit, thus molecular fragments indicative of species existing on the surfaces prior to analysis. Under these conditions, the sampling depth was approximately 1-3 monolayers. The primary beam potential was 12 kV (+ions), 18 kV (−ions); primary ion current (DC) was 1 nA; and the nominal analysis region was 100 um². A sample was “free silicone” if there was no detection of PDMS or 0.5 or less normalized amount of PDMS when using normalized intensities to compare respective samples of PDMS-containing films.

### COF Test

The outer layer containing the coextruded films made in Examples was tested under ambient temperature condition to determine the static and dynamic COF (μs and μd) using the method of ASTM D1894.

### Surface Roughness Test

The arithmetic mean roughness Ra of the coextruded polyolefin release films after metallized in a vacuum deposition chamber (belljar metallization known in the art) was measured by ZYGO NEWVIEW™ 7300 Surface Profiler manufactured by Zygo Corporation.

### Surface Energy Test

Surface energy was determined by using the known numerical relationship between surface tension in dynes/cm of a polymer surface and the contact angle of a water drop deposited onto the polymer surface (Zisman correlation). The contact angle value is also significantly impacted also by the surface roughness being tested. The contact angle was measured using a Contact Angle Meter (from Tantec, Schaumburg, Ill.) as described in U.S. Pat. No. 5,268,733.

### Tape Peeling Force Test

The method consists of cutting film stripes in dimensions 50 mm×100 mm and applying a special type of adhesive tape (Tesa Tape, Inc. TESA 7475) on top of the outer PMP release layer containing each sample. Consistent pressure of a 2 kg roller is applied on each tape to facilitate adhesion onto the PMP release film by rolling over it once with a steady hand motion. Subsequently, the laminated sheet samples with the tape attached are allowed to cure for 24 hours at ambient conditions. Subsequently, the tape release force is measured on a Release Tester, model AR-1000, from Cheminstrument, at a jaw separation speed 300 mm/min. and a peeling angle of 180°.

### Delamination Bond Test

The method used to prepare the laminated sheet samples described in the Tape Peeling Force Test is used to prepare sheet samples for delamination force test. The laminated samples were cut into one inch wide stripes, and then manually initiated a separation between the outer PMP release layer and core layer, and subsequently tested at ambient temperature using Instron Tensile Tester (90° peeling angle) for delamination bond, averaging the data of three laminated sheet sample stripes.

### Release Force Test

To achieve a good quality of drawdown coating template (pre-cast sheet) of cold seal adhesive and UV curable adhesive for easy handling and avoiding wrinkles, a stiff extrusion laminated template sheet was produced before blocking and release test using Torayfan® TC01/60 G and Torayfan® F62W/70 G, which are commercially available from Toray Plastics (America), Inc. Torayfan® TC01/60 G is two-side treated biaxially oriented polypropylene film comprising a core layer and two outer layers. Torayfan® F62W/70 G is one-side treated biaxially oriented polypropylene film comprising a core layer and two outer layers. The thickness of the LDPE adhesion in lamination was about 10 #/ream and about 60 G in thickness, the extrusion lamination was conducted at extrusion temperature 315° C. and lamination speed 500 ftpm. The laminate has a structure of TC01/10 #LDPE/F62W and a thickness of 210 G. The corona treated side of TC01 was laminated to F62W print film, the ultra-high surface energy (UHSE) side of the TC01 film after lamination was used as the adhesive receptive layer containing drawdown coating. Dow Chemical COSEAL™ 30061A was used to prepare the pre-cast sheet of drawdown coated cold seal adhesive. Actega Rad-bond™ 12PS12LVFB was used to prepare the pre-cast sheet of drawdown-coated PSA adhesive.

Cold seal adhesive: the drawdown coating was conducted using Mayer Rod #6 and COSEAL™ 30061A cold seal adhesive, which give precast sheet with a coat weight of about 3.5 to 3.7 #/ream. After the drawdown was complete, the template was dried in a 120° C. oven for 5 seconds and then the coated template was cooled down in ambient temperature condition to complete the preparation of pre-cast sheet. The outer layer containing a cold seal release film sample was then flatly stacked onto the cold seal adhesive layer containing the pre-cast sheet.

UV curable pressure sensitive adhesive: the drawdown coating was conducted using Mayer Rod #2 and RAD-BOND™ 12PS12LVFB, having a dry coat weight about 5.5 to 6.5 #/ream (nominal dry adhesive thickness 10 μm). After the drawdown was complete on the template, the coated PSA adhesive template on a conveyor was cured in UVPS oven armed with UV lamp which has an energy output nominal 400 WPI (watts per inch) by passing the UV oven at a conveyor speed of 24 fpm for three times under ambient condition to complete the preparation of the pre-cast sheet. The dimension of coated sample size was 4 in×6 in. The outer PMP release layer containing a PMP release film sample was then flatly stacked onto the cured PSA layer containing a pre-cast sheet.

A maximum of 12 stacks separated by a sheet of A4 paper of the stacked samples were inserted into a blocking jig for varying test conditions (The blocking jig was manufactured by Koehler Instruments Co.). The conditions for ambient include that a temperature of about 22° C., 16 hours duration time, compression pressure 100 PSI (the head of blocking jig on the stacked samples). Under heat-aged condition, the blocking jig was put into an oven with a 50° C. setting temperature. The duration time and compression pressure were the same as that of ambient condition.

After blocked samples were prepared under either ambient or heat aged conditions described above, the blocked samples cut into one inch wide stripes and then tested at ambient temperature using Instron (90° peeling angle) for release force, averaging the data of three blocked sample stripes.

### APPENDIX

TABLE 7
First Outer Layer (Layer A): Ingredients and amounts by wt %

| | Group I | | | | | | | | | | |
|---|---|---|---|---|---|---|---|---|---|---|---|
| | 1 | 2 | 3 | 4 | 5 | 6 | 7 | 8 | 9 | 10 | 11 |
| PMP | 88.75 | 86.25 | 84 | 80 | 83 | 78.6 | 78.6 | 78.6 | 81.7 | 81.7 | 81.7 |
| Mini | 0 | 0 | 0 | 0 | | 0 | 0 | 0 | 0 | 0 | 0 |
| ran- | | | | | | | | | | | |
| dom | | | | | | | | | | | |
| PP | | | | | | | | | | | |
| resin | | | | | | | | | | | |
| Bu- | 9 | 9 | 9 | 9 | 9 | 10 | 10 | 10 | 10 | 10 | 10 |
| tene-1 | | | | | | | | | | | |
| co- | | | | | | | | | | | |
| poly- | | | | | | | | | | | |
| mer | | | | | | | | | | | |
| PDMS | 1.25 | 3.75 | 1.5 | 2.5 | 3 | 5 | 5 | 5 | 0 | 0 | 2 |
| Cross- | 0 | 0 | 0 | 0 | 0.4 | 0.3 | 0.3 | 0.3 | 0.4 | 0.4 | 0.3 |
| linked | | | | | | | | | | | |
| sili- | | | | | | | | | | | |
| cone | | | | | | | | | | | |
| Flu- | 0.05 | 0.05 | 0.05 | 0.05 | 0.015 | 0.015 | 0.015 | 0.015 | 0.015 | 0.015 | 0.015 |
| oro- | | | | | | | | | | | |
| poly- | | | | | | | | | | | |
| mer | | | | | | | | | | | |
| EP | 0.95 | 0.95 | 0.95 | 0.95 | 0.985 | 0.985 | 0.985 | 0.985 | 0.985 | 0.985 | 0.985 |
| co- | | | | | | | | | | | |
| poly- | | | | | | | | | | | |
| mer | | | | | | | | | | | |
| Homo- | 0 | 0 | 4.5 | 7.5 | 10 | 0 | 0 | 0 | 0 | 0 | 0 |
| PP | | | | | | | | | | | |
| PP | 0 | 0 | 0 | 0 | 7.6 | 5.7 | 5.7 | 5.7 | 7.6 | 7.6 | 5.7 |
| co- | | | | | | | | | | | |
| poly- | | | | | | | | | | | |
| mer | | | | | | | | | | | |
| Corona | No | No | No | No | No | No | Yes | Yes | No | Yes | No |
| dis- | | | | | | | (0.1 | (1 | | (1 | |
| charge | | | | | | | Kw) | KW) | | KW) | |
| | Group I | | | | Group II | | | | | Range based | |
| | 12 | 13 | 14 | 15 | 16 | 17 | 18 | 19 | | on examples | |
| PMP | 81.7 | 80 | 80 | 80 | 0 | 0 | 0 | 0 | | 0 to 88.75 | |
| Mini | 0 | 0 | 0 | 0 | 100 | 100 | 100 | 100 | | 0 to 100 | |
| ran- | | | | | | | | | | | |
| dom | | | | | | | | | | | |
| PP | | | | | | | | | | | |
| resin | | | | | | | | | | | |
| Bu- | 10 | 10 | 10 | 10 | 0 | 0 | 0 | 0 | | 0 to 10 | |
| tene-1 | | | | | | | | | | | |
| co- | | | | | | | | | | | |
| poly- | | | | | | | | | | | |
| mer | | | | | | | | | | | |
| PDMS | 2 | 3 | 3 | 3 | 0 | 0 | 0 | 0 | | 0 to 5 | |
| Cross- | 0.3 | 0.3 | 0.3 | 0.3 | 0 | 0 | 0 | 0 | | 0 to 04 | |
| linked | | | | | | | | | | | |
| sili- | | | | | | | | | | | |
| cone | | | | | | | | | | | |
| Flu- | 0.015 | 0.05 | 0.05 | 0.05 | 0 | 0 | 0 | 0 | | 0 to 0.05 | |
| oro- | | | | | | | | | | | |
| poly- | | | | | | | | | | | |
| mer | | | | | | | | | | | |
| EP | 0.985 | 0.95 | 0.95 | 0.95 | 0 | 0 | 0 | 0 | | 0 to 0.985 | |
| co- | | | | | | | | | | | |
| poly- | | | | | | | | | | | |
| mer | | | | | | | | | | | |
| Homo- | 0 | 0 | 0 | 0 | 0 | 0 | 0 | 0 | | 0 to 10 | |
| PP | | | | | | | | | | | |
| PP | 5.7 | 5.7 | 5.7 | 5.7 | 0 | 0 | 0 | 0 | | 0 to 7.6 | |
| co- | | | | | | | | | | | |
| poly- | | | | | | | | | | | |
| mer | | | | | | | | | | | |
| Co- | Yes | No | No | No | Yes | Yes | Yes | Yes | | 0.1-1 | |
| rona | (1 | | | | (1 | (1 | (1 | (1 | | KW | |
| dis- | KW) | | | | KW) | KW) | KW) | KW) | | | |
| charge | | | | | | | | | | | |

TABLE 8
Core Layer (Layer B): Ingredients and amounts by wt %

| | | | | | | | | | | | | | | | | | | | | Range |
|---|---|---|---|---|---|---|---|---|---|---|---|---|---|---|---|---|---|---|---|---|
| | | | | | | | | | | | | | | | | | | | | based on |
| | 1 | 2 | 3 | 4 | 5 | 6 | 7 | 8 | 9 | 10 | 11 | 12 | 13 | 14 | 15 | 16 | 17 | 18 | 19 | examples |
| Homo- | 100 | 100 | 100 | 100 | 100 | 100 | 100 | 100 | 100 | 100 | 100 | 100 | 100 | 100 | 100 | 100 | 100 | 100 | 100 | 100 |
| PP | | | | | | | | | | | | | | | | | | | | |

TABLE 9
Second Outer Layer (Layer C): Ingredients and amounts by wt %

| | | | | | | | | | | | | | | | | | | | | Range |
|---|---|---|---|---|---|---|---|---|---|---|---|---|---|---|---|---|---|---|---|---|
| | | | | | | | | | | | | | | | | | | | | based |
| | Group IA | | | | | | | | Group IB | | | | | | | Group II | | | | on ex- |
| | 1 | 2 | 3 | 4 | 5 | 6 | 7 | 8 | 9 | 10 | 11 | 12 | 13 | 14 | 15 | 16 | 17 | 18 | 19 | amples |
| Homo | 99.99 | 99.99 | 99.99 | 99.99 | 99.99 | 99.99 | 99.99 | 99.99 | 0 | 0 | 0 | 0 | 0 | 0 | 0 | 0 | 0 | 6 | 3.75 | 0 to 99.9 |
| PP | | | | | | | | | | | | | | | | | | | | |
| PMP | 0 | 0 | 0 | 0 | 0 | 0 | 0 | 0 | 81.7 | 81.7 | 81.7 | 81.7 | 80 | 80 | 80 | 0 | 0 | 0 | 0 | 0 to 81.7 |
| Sili- | 0.01 | 0.01 | 0.01 | 0.01 | 0.01 | 0.01 | 0.01 | 0.01 | 0 | 0 | 0 | 0 | 0 | 0 | 0 | 0 | 0 | 0 | 0 | 0 to 0.01 |
| cate# | | | | | | | | | | | | | | | | | | | | |
| Bu- | 0 | 0 | 0 | 0 | 0 | 0 | 0 | 0 | 10 | 10 | 10 | 10 | 10 | 10 | 10 | 0 | 0 | 0 | 0 | 0 to 10 |
| tene-1 | | | | | | | | | | | | | | | | | | | | |
| copoly- | | | | | | | | | | | | | | | | | | | | |
| mer | | | | | | | | | | | | | | | | | | | | |
| PDMS | 0 | 0 | 0 | 0 | 0 | 0 | 0 | 0 | 0 | 0 | 2 | 2 | 3 | 3 | 3 | 0 | 0 | 2 | 1.25 | 0 to 3 |
| Cross- | 0 | 0 | 0 | 0 | 0 | 0 | 0 | 0 | 0.4 | 0.4 | 0.3 | 0.3 | 0.3 | 0.3 | 0.3 | 0 | 0 | 0 | 0.25 | 0 to 0.4 |
| linked | | | | | | | | | | | | | | | | | | | | |
| silicone | | | | | | | | | | | | | | | | | | | | |
| PP | 0 | 0 | 0 | 0 | 0 | 0 | 0 | 0 | 7.6 | 7.6 | 5.7 | 5.7 | 5.7 | 5.7 | 5.7 | 0 | 0 | 0 | 4.75 | 0 to 7.6 |
| copoly- | | | | | | | | | | | | | | | | | | | | |
| mer | | | | | | | | | | | | | | | | | | | | |
| Fluoro- | 0 | 0 | 0 | 0 | 0 | 0 | 0 | 0 | 0.015 | 0.015 | 0.015 | 0.015 | 0.05 | 0.05 | 0.05 | 0 | 0 | 0 | 0 | 0 to 0.05 |
| polymer | | | | | | | | | | | | | | | | | | | | |
| EP | 0 | 0 | 0 | 0 | 0 | 0 | 0 | 0 | 0.985 | 0.985 | 0.985 | 0.985 | 0.95 | 0.95 | 0.95 | 0 | 0 | 0 | 0 | 0 to 0.985 |
| copoly- | | | | | | | | | | | | | | | | | | | | |
| mer | | | | | | | | | | | | | | | | | | | | |
| HCPP | 0 | 0 | 0 | 0 | 0 | 0 | 0 | 0 | 0 | 0 | 0 | 0 | 0 | 0 | 0 | 100 | 0 | 0 | 0 | 0 to 100 |
| PMP | 0 | 0 | 0 | 0 | 0 | 0 | 0 | 0 | 0 | 0 | 0 | 0 | 0 | 0 | 0 | 0 | 100 | 92 | 90 | 0 to 100 |
| copoly- | | | | | | | | | | | | | | | | | | | | |
| mer | | | | | | | | | | | | | | | | | | | | |
| Corona | No | No | No | No | No | No | No | No | Yes | Yes | Yes | Yes | No | Yes | Yes | No | No | No | No | 1-5 KW |
| dis- | | | | | | | | | (1 | (1 | (1 | (1 | | (2.7 | (5 | | | | | |
| charge | | | | | | | | | KW) | KW) | KW) | KW) | | KW) | KW) | | | | | |

# Silton ® JC 30 is an anti-blocking agent with nominal 3 μm particle size of a spherical sodium calcium aluminum silicate

What is claimed is:

1. A multilayer film comprising a core layer and a first outer layer; wherein the core layer comprises a first polypropylene; and wherein the first outer layer comprises (a) a first polymethylpentene and (b) a first polydimethylsiloxane and/or a first crosslinked silicone.

2. The multilayer film of claim 1, wherein the first outer layer further comprises a first butene copolymer.

3. The multilayer film of claim 2, wherein the first outer layer further comprises a first fluoropolymer.

4. The multilayer film of claim 3, wherein the first outer layer further comprises a first ethylene-propylene copolymer.

5. The multilayer film of claim 4, wherein the first outer layer further comprises a first polypropylene copolymer.

6. The multilayer film of claim 5, wherein the first outer layer comprises a first corona treated surface.

7. The multilayer film of claim 1, further comprising a second outer layer, wherein the second outer layer comprises a second polypropylene and a silicate.

8. The multilayer film of claim 2, further comprising a second outer layer, wherein the second outer layer comprises (a) a second polymethylpentene, (b) a second butene copolymer, and (c) a second polydimethylsiloxane and/or a second crosslinked silicone.

9. The multilayer film of claim 8, wherein the second outer layer further comprises a second fluoropolymer.

10. The multilayer film of claim 9, wherein the second outer layer further comprises a second ethylene-propylene copolymer.

11. The multilayer film of claim 10, wherein the second outer layer further comprises a second polypropylene copolymer.

12. The multilayer film of claim 11, wherein the second outer layer comprises a second corona treated surface.

13. The multilayer film of claim 1, wherein the first outer layer comprises the first polydimethylsiloxane and the first crosslinked silicone.

14. The multilayer film of claim 1, wherein the core layer further comprises a hydrogenated hydrocarbon resin.

15. The multilayer film of claim 1, wherein the multilayer film is free of silicone.

16. A multilayer film comprising a core layer and a first outer layer; wherein the core layer comprises polypropylene; and wherein the first outer layer comprises a mini random polypropylene resin, wherein the first outer layer comprises a first corona treated surface.

17. The multilayer film of claim 16, further comprising a second outer layer comprising a polymethylpentene copolymer.

18. The multilayer film of claim 16, further comprising a second outer layer comprising a crystalline polypropylene, a second polydimethylsiloxane, a second crosslinked silicone and/or a second fluoropolymer.

19. The multilayer film of claim 17, wherein the second outer layer further comprises a second polydimethylsiloxane, a second crosslinked silicone and/or a second fluoropolymer.

20. The multilayer film of claim 17, wherein the second outer layer further comprises a second polydimethylsiloxane, a second crosslinked silicone and a second fluoropolymer.

21. The multilayer film of claim 16, wherein the core layer further comprises a hydrogenated hydrocarbon resin.

22. The multilayer film of claim 16, wherein the multilayer film is free of silicone.

23. The multilayer film of claim 16, wherein the multilayer film is completely free of silicone.
